(19) United States
(12) Patent Application Publication
(10) Pub. No.: US 2026/0320862 A1
(43) Pub. Date: Oct. 15, 2026

(54) GENERATING COMPOSITE DIGITAL DESIGNS USING A MULTI-MODAL DIFFUSION MODEL

(71) Applicant: Adobe Inc., San Jose, CA (US)

(72) Inventors: Vlad-Constantin Lungu-Stan, Bucharest (RO); Alexandru-Gabriel Ilie, Ploiesti (RO); Madalin Dumitru-Guzu, Bucharest (RO); Ionut Mironica, Bucharest (RO); Alexandru Vasile Costin, Monte Sereno, CA (US)

(21) Appl. No.: 19/176,508

(22) Filed: Apr. 11, 2025

(51) Int. Cl. G06T 11/60; G06F 40/284; G06F 40/40

(52) U.S. Cl. CPC G06T 11/60; G06F 40/284; G06F 40/40; G06T 2200/24

(57) ABSTRACT

The present disclosure relates to systems, non-transitory computer-readable media, and methods for generating a target digital design based on a text description. The disclosed systems utilize one or more encoder neural networks to generate a set of input tokens from a prompt comprising a description of a target digital design and one or more categorical parameters from the target digital design. The disclosed systems utilize a diffusion neural network to generate a plurality of design layers including digital design elements according to the description of the target digital design and based on the set of input tokens. The disclosed systems provide, for display within a digital design application of a client device, the target digital design having document attributes corresponding to the one or more categorical parameters and including the digital design elements of the plurality of design layers as separately interactive elements.

### BACKGROUND

Improvements to digital content processing using neural networks have increased the prevalence of diffusion neural networks in digital design generation and editing workflows. Due to the functionality of transformer neural networks, a key challenge in generating digital designs utilizing diffusion neural networks involves generating visually coherent, structured digital designs with interdependent elements. Specifically, structured digital designs include individually meaningful elements that overlap and/or otherwise combine to create a complete element (e.g., separate image components that combine to make a single, complete image element). Additionally, interdependent elements in digital designs include visually compatible and dependent elements that fit together to form a larger design. Accordingly, ensuring that a digital design has visually coherent elements that work together as part of an overall design strategy for the digital design is an important and challenging aspect of digital content design. Although some existing systems generate digital designs utilizing diffusion neural networks, the existing systems exhibit a number of drawbacks or disadvantages in generating structured digital designs.

### SUMMARY

This disclosure describes one or more embodiments of systems, methods, and non-transitory computer readable media that solve one or more of the foregoing or other problems in the art by utilizing a diffusion neural network to generate a composite digital design with individually editable elements. Specifically, the disclosed systems generate design layers including digital design elements for a digital design based on a text description of a target digital design. In one or more embodiments, the disclosed systems utilize one or more encoder neural networks to generate a set of input tokens representing the text description and one or more categorical parameters such as document type, aspect ratio, stylization and mood, or number of layers. In one or more embodiments, the disclosed systems utilize a diffusion neural network to generate design layers including various digital design elements of various types based on the set of input tokens. Furthermore, the disclosed systems generate the composite digital design with individual digital design elements based on the design layers and present the composite digital design for display to a client device for interacting with the individual digital design elements.

### BRIEF DESCRIPTION OF THE DRAWINGS

The disclosure describes one or more embodiments of the invention with additional specificity and detail by referencing the accompanying figures. The following paragraphs briefly describe those figures.

FIG. 1 illustrates a diagram of an environment in which a layered design generation system operates in accordance with one or more embodiments.

FIG. 2 illustrates a diagram of an overview of the layered design generation system utilizing encoder neural network(s) and a diffusion neural network to generate a target digital design in accordance with one or more embodiments.

FIG. 3 illustrates a diagram of the layered design generation system generating text embeddings in accordance with one or more embodiments.

FIG. 4 illustrates a diagram of the layered design generation system generating a set of input tokens from various prompt embeddings in accordance with one or more embodiments.

FIG. 5 illustrates a diagram of the layered design generation system generating a target digital design from a set of input tokens in accordance with one or more embodiments.

FIG. 6 illustrates examples of the layered design generation system generating target digital designs from design layers in accordance with one or more embodiments.

FIG. 7 illustrates an example of a graphical user interface displaying an interactable layered digital design in accordance with one or more embodiments.

FIG. 8 illustrates a diagram of the layered design generation system training a diffusion neural network to generate editable composite digital designs in accordance with one or more embodiments.

FIG. 9 illustrates an example schematic diagram of the layered design generation system in accordance with one or more embodiments.

FIG. 10 illustrates an example flowchart of a series of acts for generating a target digital design in accordance with one or more embodiments.

FIG. 11 shows an example of a guided diffusion model according to aspects of the present disclosure.

FIG. 12 shows an example of a U-Net according to aspects of the present disclosure.

FIG. 13 shows an example of a method for conditional media generation according to aspects of the present disclosure.

FIG. 14 shows a diffusion process according to aspects of the present disclosure.

FIG. 15 shows a flow diagram depicting an algorithm as a step-by-step procedure for training a machine-learning model according to aspects of the present disclosure.

FIG. 16 shows an example of a method for training a diffusion model according to aspects of the present disclosure.

FIG. 17 shows an example of a computing device according to aspects of the present disclosure.

FIG. 18 shows an example of a synthesized image generation apparatus according to aspects of the present disclosure.

FIG. 19 illustrates a block diagram of an example computing device in accordance with one or more embodiments.

### DETAILED DESCRIPTION

This disclosure describes one or more embodiments of a layered design generation system that generates single page composite digital designs utilizing one or more encoder neural networks and a diffusion neural network. For example, the layered design generation system utilizes one or more encoder neural networks to generate a set of input tokens representing a natural language description of a target digital design and in some cases one or more categorical parameters for the target digital design. The layered design generation system leverages a diffusion neural network to generate design layers with digital design elements based on the set of input tokens, for example, by placing non-overlapping digital design elements of the same design type in a corresponding design layer. In one or more embodiments, the layered design generation system generates the target digital design including separately editable digital design elements from the design layers and presents the target digital design for display and editing at a client device.

As mentioned, in one or more embodiments, the layered design generation system generates a set of input tokens utilizing one or more encoder neural networks. Specifically, the layered design generation system processes an initial natural language description of a target digital design through a large language model (“LLM”) to format and/or expand on the initial natural language description to obtain an expanded description for the encoder neural network. In one or more embodiments, the layered design generation system determines categorical parameters defining one or more parameters of the target digital design (e.g., document type, aspect ratio, stylization and mood, and number of layers) for generating the set of input tokens. In certain embodiments, the layered design generation system generates an optional image embedding to condition the style of the target digital design according to a reference digital design for generating the set of input tokens.

In one or more embodiments, the layered design generation system utilizes a diffusion neural network to generate a set of design layers based on the set of input tokens. In particular, the layered design generation system utilizes the diffusion neural network to generate design layers including non-overlapping digital design elements of the same digital design types (e.g., image, text, text boxes, vector, overlay). Thus, the layered design generation system utilizes the diffusion neural network to synthesize digital design elements of various digital design types by grouping similar digital design elements into the same design layer. In one or more additional embodiments, the layered design generation system groups together text elements that overlap heavily in the same design layer.

In one or more embodiments, the layered design generation system generates the target digital design from the design layers. In particular, the layered design generation system generates the design layers in a single operation (e.g., via a single set of input tokens to the diffusion neural network) to capture the structural dependencies of the digital design elements within the design layers. Further, in some embodiments, the layered design generation system extracts the digital design elements from the generated design layers and provides the target digital design for display on a client device. In one or more embodiments, the layered design generation system presents the target digital design as an editable file including discrete digital design elements from the design layers for individual selection and editing.

In one or more embodiments, the layered design generation system trains the diffusion neural network to predict a target digital design including separately editable digital design elements. In particular, the layered design generation system utilizes a dataset including a set of sample layered digital designs and a set of sample unlayered digital designs. In one or more embodiments, the layered design generation system utilizes the set of sample layered digital designs to train the diffusion neural network on digital design structure and how to split digital design elements properly. The layered design generation system utilizes the set of sample unlayered digital designs to train the diffusion neural network to learn visual aesthetics/attributes of a digital design.

As suggested above, existing systems exhibit drawbacks or deficiencies in generating structured digital designs that capture the interdependencies of digital design elements. Although some conventional systems generate digital designs utilizing diffusion models, such systems have a number of problems or inadequacies in relation to accuracy and flexibility. For instance, conventional systems inaccurately generate simplistic or generic digital designs that fail to capture the requested complexities and structure of a target digital design. To illustrate, some conventional systems utilize diffusion neural networks to generate digital designs with random sampling, leading to unrefined outputs and inconsistent quality standards. Further, some conventional systems generate digital designs that do not meet specific quality standards, requiring repeated sampling, which leads to inconsistencies and an overall lack of coherence in generated digital designs.

Additionally, conventional systems are inflexible. For instance, certain conventional systems are limited to providing users with simple template recommendations based on their search criteria with limited options for customization. Also, existing systems that suggest layout adjustments or color palettes using predefined rules are limited to predefined assets and require an initial design to generate variations, which thus often requires many additional edits and extensive knowledge of editing tools. Further, many existing systems that use retrieval-augmented generation to enhance the design process are dependent on a broad template repository of high-quality digital designs and require the ability to understand nuanced prompts.

As suggested, embodiments of the layered design generation system provide several advantages and benefits over conventional systems. For example, the layered design generation system improves accuracy over prior systems. In contrast to conventional systems that generate flat, simplistic, generic digital designs using conventional diffusion prompts, the layered design generation system utilizes a framework of one or more encoder neural networks and a diffusion neural network to generate design layers for creating editable digital designs that capture specific digital design element structures and interdependencies. By generating a plurality of design layers incorporating digital design elements of various digital design element types, the layered design generation system captures the complexities and structures requested by a user in a natural language description. Additionally, by generating a plurality of design layers in a structured manner, the layered design generation system generates refined digital designs with consistent standards. By so doing, the layered design generation system generates accurate target digital designs, eliminating the need for repeated sampling or image generation operations via a diffusion neural network.

The layered design generation system also improves flexibility relative to conventional systems. Specifically, by generating digital designs based off a single text description, the layered design generation system provides expansive options for customization. In particular, in contrast to conventional systems that provide limited template recommendations, the layered design generation system generates digital designs with varied content and separately editable digital design elements by leveraging a diffusion neural network to create layered digital design elements according to learned digital design attributes and structures. Further, the layered design generation system generates digital designs according to a text description in a prompt to a diffusion neural network, eliminating reliance on predefined assets or an initial design. In some cases, the layered design generation system also improves the ability to understand nuanced prompts by introducing categorical parameters and by expanding the natural language description through an LLM.

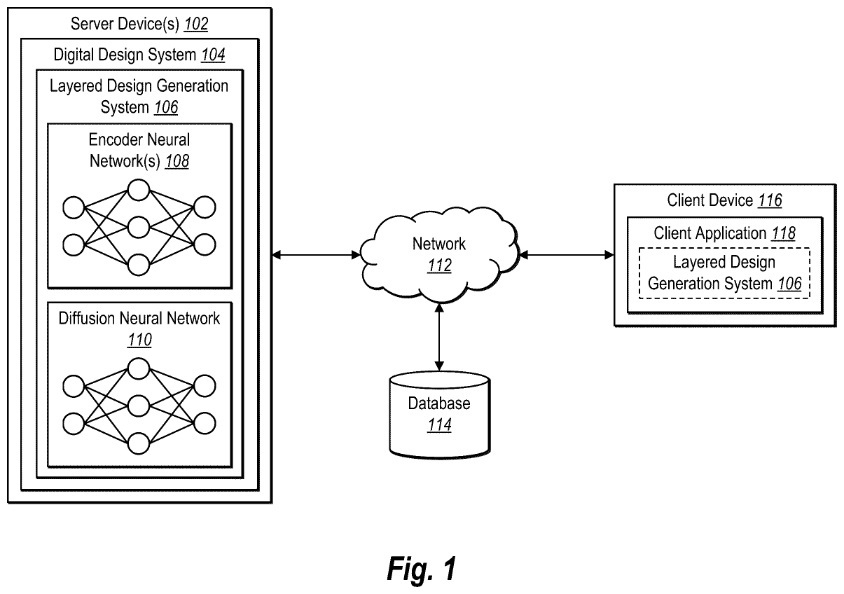

Additional detail regarding the layered design generation system 106 will now be provided with reference to the figures. For example, FIG. 1 illustrates a schematic diagram of an example system environment for implementing a layered design generation system 106 in accordance with one or more embodiments. An overview of the layered design generation system 106 is described in relation to FIG. 1. Thereafter, a more detailed description of the components and processes of the layered design generation system 106 is provided in relation to the subsequent figures.

As shown, the environment includes server device(s) 102, a database 114, a network 112, and a client device 116. Each of the components of the environment communicate via the network 112, and the network 112 is any suitable network over which computing devices communicate.

As mentioned, the environment includes a client device 116. The client device 116 is one of a variety of computing devices, including a smartphone, a tablet, a smart television, a desktop computer, a laptop computer, a virtual reality device, an augmented reality device, or another computing device. The client device 116 communicates with the server device(s) 102 via the network 112. For example, the client device 116 provides information to server device(s) 102 indicating client device interactions (e.g., receiving a text prompt, selecting a sample digital design, selecting an interactive digital design element) and receives information from the server device(s) 102 (e.g., a target digital design). Thus, in some cases, the layered design generation system 106 on the server device(s) 102 provides and receives information based on client device interaction via the client device 116.

As shown in FIG. 1, the client device 116 includes a client application 118. In particular, the client application 118 is a web application, a native application installed on the client device 116 (e.g., a mobile application, a desktop application, etc.), or a cloud-based application where all or part of the functionality is performed by the server device(s) 102. Based on instructions from the client application 118, the client device 116 presents or displays information to a user. For example, the client device 116 presents target digital designs according to a text prompt as generated by the layered design generation system 106 and interpreted by a processor (e.g., a graphics processor) and/or renderer on the client device 116. In some cases, the client device 116 includes a version of the layered design generation system 106.

As illustrated in FIG. 1, the environment includes the server device(s) 102. The server device(s) 102 generates, tracks, stores, processes, receives, and transmits electronic data, such as text prompts, reference digital designs, training information, and target digital designs. The server device(s) 102, for example, receives data form the client device 116 in the form of an indication of a client device interaction (e.g., a text prompt, a reference digital design, or an interaction with an interactive digital design element) to generate a target digital design from the client device interaction. In response, the server device(s) 102 transmits data to the client device 116 to display or present a target digital design based on the client device interaction.

In some embodiments, the server device(s) 102 communicates with the client device 116 to transmit and/or receive data via the network 112 including client device interactions, digital images, text prompts, and/or other data. In some embodiments, the server device(s) 102 comprises a distributed server where the server device(s) 102 includes a number of server devices distributed across the network 112 and located in different physical locations. The server device(s) 102 comprise a content server, an application server, a communication server, a content editing server, a web-hosting server, a multidimensional server, and/or a machine learning server. The server device(s) further access and utilize the database 114 to store and retrieve information such as digital designs, training information, and all or part of the encoder neural network(s) 108 and the diffusion neural network 110.

In some cases, an encoder neural network includes a neural network architecture designed to process input data to generate a compressed representation of it. In particular, an encoder neural network maps input data, such as images, text, or signals, to a lower-dimensional space to retain essential features while reducing the dimensionality of the data. For example, an encoder neural network processes the input through multiple layers of neurons performing operations such as weighted summation, activation functions, and dimensionality reduction to encode the data into a compact, fixed-length vector representation.

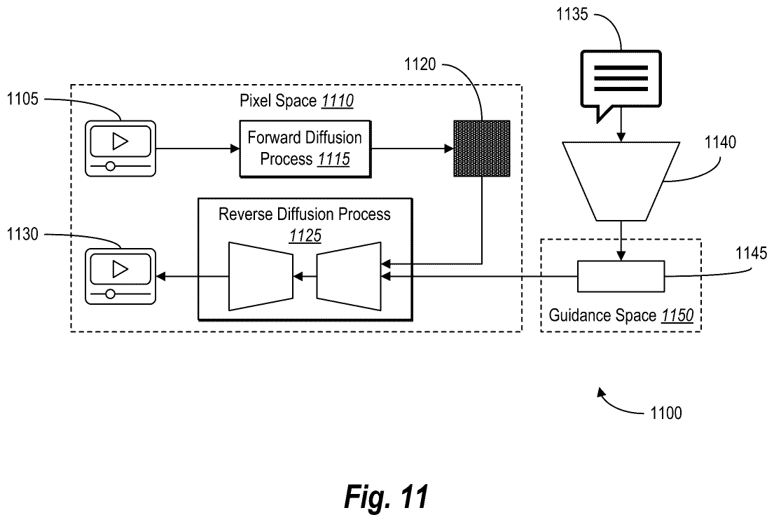

In some cases, a diffusion neural network (or diffusion model) includes a neural network architecture designed to model diffusion of data over time. In particular, a diffusion neural network models gradual transformation of data from random noise to structured outputs by simulating its diffusion across a system. For example, a diffusion neural network iteratively applies learned transformations in tasks such as generative modeling (e.g., generating target digital designs) by iteratively noising and then reconstructing the data step by step. FIGS. 11-18 and the corresponding description provide additional detail related to diffusion neural networks.

Relatedly, in some embodiments, a neural network includes or refers to a machine learning model trained and/or tuned based on inputs to determine classifications, scores, or approximate unknown functions. For example, a neural network includes a model of interconnected artificial neurons (e.g., organized in layers) that communicate and learn to approximate complex functions and generate outputs (e.g., target digital designs) based on a plurality of inputs provided to the neural network. In some cases, a neural network implements deep learning techniques to model high-level abstractions in data. A neural network includes various layers such as an input layer, one or more hidden layers, and an output layer that each perform tasks for processing data. For example, a neural network includes a diffusion neural network, a deep neural network, a convolutional neural network, a recurrent neural network (e.g., an LSTM), a graph neural network, or a large language model.

As further shown in FIG. 1, the server device(s) 102 also includes the layered design generation system 106 as part of a digital design system 104. For example, in one or more implementations, the digital design system 104 is able to store, generate, modify, edit, enhance, provide, distribute, and/or share content such as digital designs. For example, the digital design system 104 provides tools for the client device 116, via the client application 118, to generate target digital designs using the encoder neural network(s) 108 and the diffusion neural network 110.

In one or more embodiments, the server device(s) 102 includes all, or a portion of, the layered design generation system 106. For example, the layered design generation system 106 operates on the server device(s) 102 to generate synthesized digital images. In some cases, the layered design generation system 106 utilizes, locally on the server device(s) 102 or from another network location (e.g., the database 114) the encoder neural network(s) 108 and the diffusion neural network 110 to generate a target digital design.

In certain cases, the client device 116 includes all or part of the layered design generation system 106. For example, the client device 116 generates, obtains (e.g., downloads), or utilizes one or more aspects of the layered design generation system 106 from the server device(s) 102. Indeed, in some implementations, as illustrated in FIG. 1, the layered design generation system 106 is located in whole or in part on the client device 116. For example, the layered design generation system 106 includes a web hosting application that allows the client device 116 to interact with the server device(s) 102. To illustrate, in one or more implementations, the client device 116 accesses a web page supported an/or hosted by the server device(s) 102.

In one or more embodiments, the client device 116 and the server device(s) 102 work together to implement the layered design generation system 106. For example, in some embodiments, the server device(s) 102 train the encoder neural network(s) 108 and the diffusion neural network 110 and provide the encoder neural network(s) 108 and the diffusion neural network 110 to the client device 116 for implementation. In some embodiments, the client device 116 attaches text prompts and reference digital designs, the server device(s) 102 generates the target digital design, and the client device 116 presents the target digital design for display and interaction. Furthermore, in some implementations, the client device 116 assists in generating the target digital design.

Although FIG. 1 illustrates a particular arrangement of the environment, in some embodiments, the environment has a different arrangement of components and/or may have a different number or set of components altogether. For instance, as mentioned, the layered design generation system 106 is implemented by (e.g., located entirely or in part on) the client device 116. In addition, in one or more embodiments, the client device 116 communicates directly with the layered design generation system 106, bypassing the network 112. Further, in some embodiments, the encoder neural network(s) 108 and the diffusion neural network 110 include one or more components stored in the database 114, maintained by the server device(s) 102, the client device 116, or a third-party device.

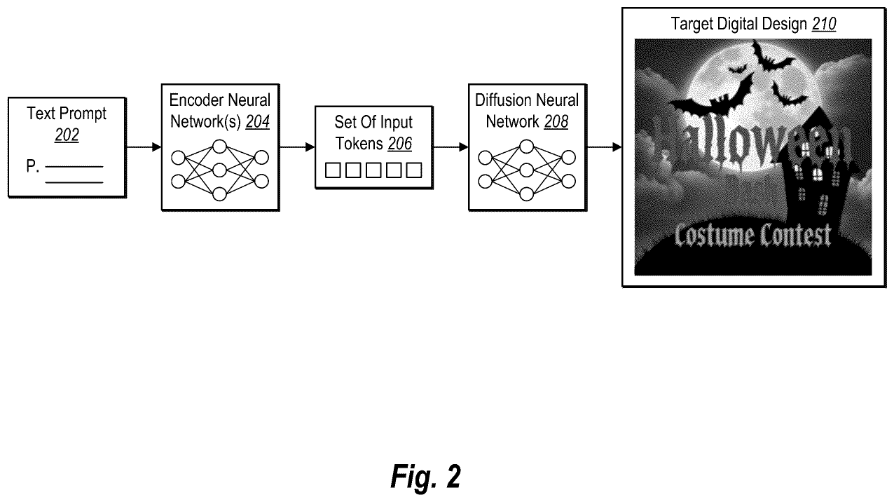

As mentioned, in one or more embodiments, the layered design generation system 106 generates a target digital design based on a text prompt. FIG. 2 illustrates an overview of the layered design generation system 106 generating a target digital design from a text prompt utilizing encoder neural network(s) and a diffusion neural network in accordance with one or more embodiments. Additional detail regarding the various acts and processes mentioned with respect to FIG. 2 is provided thereafter with respect to subsequent figures.

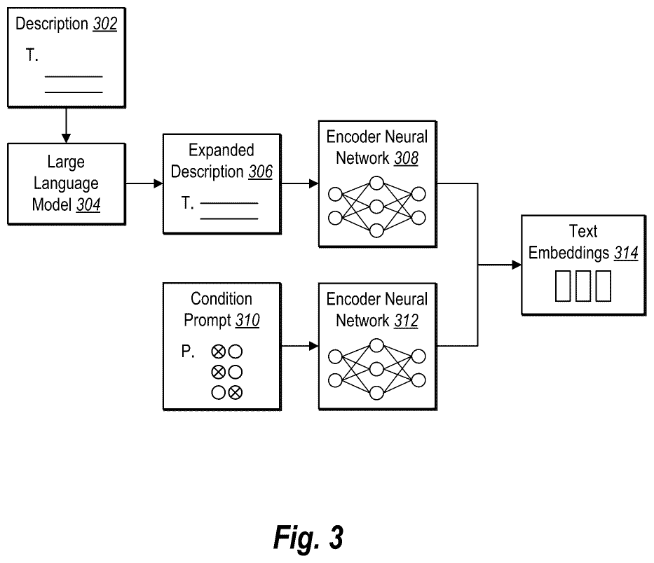

As illustrated in FIG. 2, the layered design generation system 106 receives a text prompt 202 from a client device (e.g., the client device 116 of FIG. 1). In particular, the layered design generation system 106 receives the text prompt 202 as a natural language description of a target digital design (e.g., describing a flyer for a Halloween costume contest). In one or more embodiments, the layered design generation system 106 processes the text prompt 202 to infer one or more categorical parameters (e.g., document type, aspect ratio, mood) from the natural language description of the text prompt 202. In alternative embodiments, the layered design generation system 106 receives a client device selection of one or more categorical parameters from a predefined list of categorical parameters. In one or more embodiments, the layered design generation system 106 expands the text prompt 202 via an LLM to generate an expanded description. More information on processing the text prompt 202 is provided in relation to FIG. 3.

In some cases, a prompt includes a message or input to a computing application or computing system requesting a response or action (e.g., generating a target digital design). In particular, a text prompt is a type of prompt that includes an instruction, or a set of instructions input via a user interface directing one or more neural networks to perform an action. For example, a text prompt includes a natural language description of a target digital design. In certain embodiments, a text prompt includes instructions in the form of predetermined categorical parameters guiding the generation of a target digital design via an image generation neural network such as a diffusion neural network.

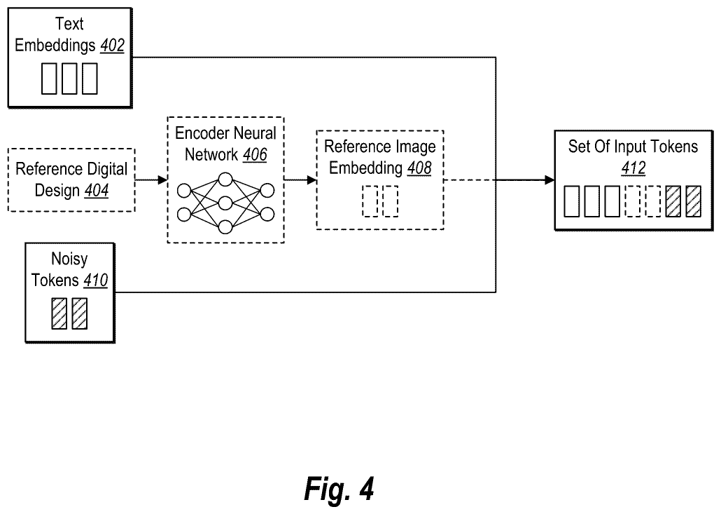

As further illustrated in FIG. 2, the layered design generation system 106 processes the text prompt 202 through an encoder neural network(s) 204 to generate a set of input tokens 206. In particular, the layered design generation system 106 utilizes the encoder neural network(s) 204 to generate the set of input tokens 206 to include a text embedding representing the text prompt 202. In one or more embodiments, the layered design generation system 106 additionally utilizes the encoder neural network(s) 204 to generate embeddings representing an optional sample digital design (e.g., in an image prompt) as part of generating the set of input tokens 206. More information on utilizing the encoder neural network(s) 204 to generate the set of input tokens 206 is provided in relation to FIG. 4.

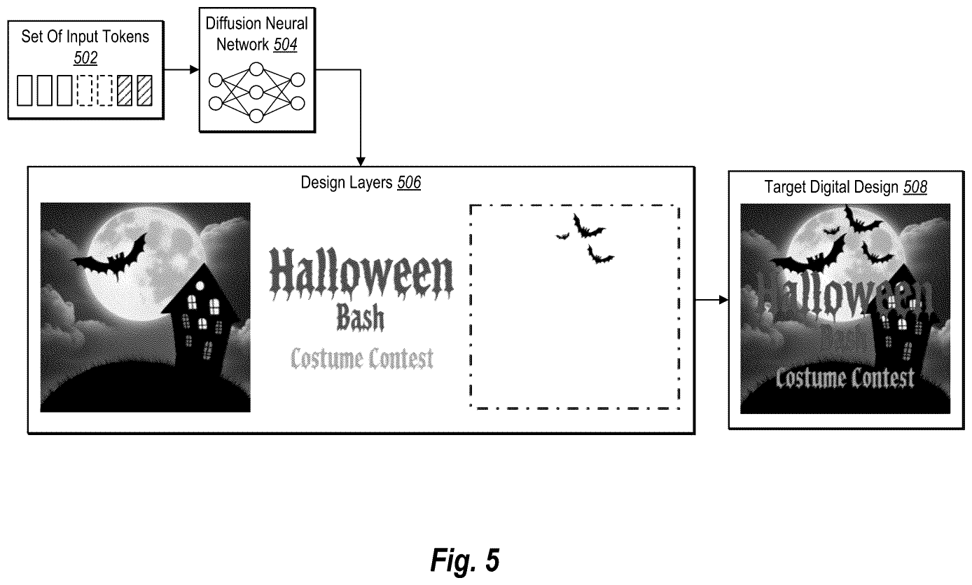

As further illustrated in FIG. 2, the layered design generation system 106 processes the set of input tokens 206 through a diffusion neural network 208 to generate a target digital design 210. In particular, the layered design generation system 106 generates the target digital design 210 based on the set of input tokens 206, which represents the description given in the text prompt 202 (e.g., generating a flyer for a Halloween costume contest). In one or more embodiments, the layered design generation system 106 generates the target digital design 210 by generating a plurality of design layers including non-overlapping digital design elements of the same type (e.g., objects, shapes, text) and generating a composite digital design based on the design layers. In one or more embodiments, the layered design generation system 106 presents the target digital design 210 to a client device (e.g., the client device 116) for display. In certain embodiments, the layered design generation system 106 presents the target digital design 210 as an interactive digital design including interactive digital design elements based on the design layers being interactive. More information on utilizing the diffusion neural network 208 to generate the target digital design 210 is provided in relation to FIG. 5.

As mentioned, in one or more embodiments, the layered design generation system 106 utilizes one or more encoder neural networks to generate an embedding from a text prompt. FIG. 3 illustrates a diagram depicting generating text embeddings from a text prompt utilizing encoder neural network(s).

As illustrated in FIG. 3, the layered design generation system 106 processes a description 302 through a large language model 304 to generate an expanded description 306. In particular, the layered design generation system 106 receives the description 302 as a natural language description of a target digital design (e.g., via a text input specifying a digital design of a flyer for a Halloween party). In one or more embodiments, the layered design generation system 106 utilizes the large language model 304 to expand on the description 302 to add additional detail, for instance, to match the format utilized by the layered design generation system 106 in training. For example, the layered design generation system 106 prompts the large language model 304 with the description 302, and the large language model 304 generates the expanded description 306 (e.g., a paragraph or other set of instructions describing the mood, background, and other assets of a flyer for a Halloween costume contest). In one or more embodiments, the layered design generation system 106 prompts the large language model 304 to generate the expanded description 306 based on one or more categorical parameters (e.g., the condition prompt 310) described in more detail below. In one or more embodiments, the layered design generation system 106 generates the expanded description 306 as a data object (e.g., a JSON).

In some cases, a large language model (“LLM”) refers to a neural network architecture trained to perform computer tasks to generate or identify computing code and/or data in response to prompts. In particular, a large language model includes a neural network (e.g., a deep neural network) with many (e.g., billions of) parameters trained on large quantities of data (e.g., unlabeled text) using a particular learning technique (e.g., self-supervised learning). For example, a large language model includes parameters trained to understand and generate text analogous to human text, such as synthetic prompts, synthetic responses, satisfaction labels, information data objects, and/or conversational goals. In one or more embodiments, LLMs use large datasets to analyze and predict language patterns to perform tasks like translation, summarization, and conversation. Further, in some embodiments, LLMs are built in a deep learning framework with many parameters to allow them to infer meaning, enabling sophisticated interactions across various domains.

As further illustrated in FIG. 3, the layered design generation system 106 processes the expanded description 306 through an encoder neural network 308 to generate text embeddings 314. In particular, the layered design generation system 106 utilizes the encoder neural network 308 to extract features from the expanded description 306, capturing the attributes described in the description 302 and the additional detail generated by the large language model 304. In one or more embodiments, the layered design generation system 106 generates a text embedding from the expanded description 306 and combines the text embedding with one or more other embeddings to form the text embeddings 314. In one or more embodiments, the encoder neural network 308 includes a pre-trained, transformer-based, text-to-text encoder-decoder neural network.

In some cases, an embedding refers to a representation of data in a different format or space. In particular, an embedding involves mapping high-dimensional data, such as words (e.g., the description 302 or the expanded description 306) or images (e.g., the reference digital design 404 of FIG. 4), into a lower-dimensional vector space while preserving its meaning or relationships. For example, embeddings represent data in dense, fixed-length numerical vectors which capture semantic or structural relationships in text content and/or image content for later analyzing or processing. In various embodiments, one or more encoder neural networks generate text embeddings and image embeddings in separate feature spaces or in a shared feature space.

As further illustrated in FIG. 3, the layered design generation system 106 receives a condition prompt 310 defining one or more categorical parameters. In particular, the condition prompt 310 includes one or more categorical parameters defining attributes of a target digital design (e.g., the document type, the document aspect ratio, the document style, and the document mood). In one or more embodiments, the layered design generation system 106 receives the condition prompt 310 as client device selections of categorical parameters from a list of predefined categorical parameters (e.g., a list of supported aspect ratios or document types, one or more predetermined styles for which a diffusion neural network has been trained). In certain embodiments, the layered design generation system 106 infers the condition prompt 310 based on textual information within the description 302 or the expanded description 306 (e.g., based on text describing a spooky mood of a poster for a Halloween costume contest).

As further illustrated in FIG. 3, the layered design generation system 106 utilizes an encoder neural network 312 to extract embeddings from the condition prompt 310 to form the text embeddings 314. According to one or more embodiments, the encoder neural network 312 includes a pre-trained, tokenizer-free, byte-level encoder-decoder neural network (e.g., a tokenizer-free version of the encoder neural network 308). In one or more embodiments, the layered design generation system 106 combines the embeddings extracted from the condition prompt 310 with the embeddings extracted from the expanded description 306 to form the text embeddings 314 (e.g., by concatenating or otherwise grouping the embeddings of the expanded description 306 and the condition prompt 310). In one or more embodiments, the layered design generation system 106 combines the embeddings representing the description 302 and the condition prompt 310 at the time of determining a set of input tokens, as described in more detail with respect to FIG. 4. In certain embodiments, the layered design generation system 106 generates the text embeddings 314 by extracting embeddings from the description 302 without prompt expansion (e.g., the expanded description 306) and/or by inferring the categorical parameters of the condition prompt 310 from the description 302.

As mentioned, in one or more embodiments, the layered design generation system 106 generates a set of input tokens by combining one or more embeddings. FIG. 4 illustrates a diagram depicting combining text embeddings, an optional image embedding, and noisy tokens to form a set of input tokens.

As illustrated in FIG. 4, the layered design generation system 106 incorporates text embeddings 402 into a set of input tokens 412. For example, the layered design generation system 106 generates the text embeddings 402 according to the process described in relation to FIG. 3. In particular, the text embeddings 402 include encoded representations of text description of attributes of a target digital image, such as a natural language description (or expanded description) and/or categorical parameters as described in relation to FIG. 3. Thus, in one or more embodiments, the layered design generation system 106 concatenates embeddings representing the natural language description (or expanded description) and categorical parameters.

Further, the layered design generation system 106 incorporates noisy tokens 410 into the set of input tokens. In one or more embodiments, the layered design generation system 106 incorporates the noisy tokens for use in a diffusion neural network (e.g., the diffusion neural network 208 of FIG. 2). For example, the noisy tokens 410 include tokens representing random noise generated for denoising during a denoising process of the diffusion neural network. Accordingly, in one or more embodiments, the layered design generation system 106 concatenates the noisy tokens 410 with the text embeddings. In one or more embodiments, the layered design generation system 106 generates the noisy tokens 410 to match the number of layers generated by the layered design generation system 106, with the number generated being fixed or variable. In one or more embodiments, the layered design generation system 106 determines the number of noisy tokens according to a client device input. In one or more embodiments, the layered design generation system 106 determines the number of noisy tokens by inferring the number needed based on a description of the target digital image (e.g., the description 302 of FIG. 3).

As further illustrated in FIG. 4, in one or more embodiments, the layered design generation system 106 accesses an optional reference digital design 404, which includes an image to guide digital design generation for the target digital design. For example, in one or more embodiments, the layered design generation system 106 determines the reference digital image 404 included with a text prompt (e.g., a natural language description and/or categorical parameters) for guiding a style, object, design, or other visual attributes when generating a target digital design. In one or more additional embodiments, the layered design generation system 106 accesses the reference digital design 404 from a database of digital designs (e.g., stored on the database 114 of FIG. 1) by inferring similarities between a client device request and a stored digital design. In one or more embodiments, the layered design generation system 106 bypasses the inclusion of the reference digital design 404.

As further illustrated in FIG. 4, the layered design generation system 106 utilizes an encoder neural network 406 to generate a reference image embedding 408 from the reference digital design 404. For example, the encoder neural network 406 includes an image encoder neural network that encodes features of digital images in an embedding space. In some embodiments, the image encoder neural network 406 encodes the reference digital design 404 in a shared embedding space for text and images. In one or more embodiments, the layered design generation system 106 generates the reference image embedding 408 to represent characteristics of the reference digital design (e.g., document aspect ratio, document type, document style, document mood, document color scheme).

In one or more embodiments, the layered design generation system 106 combines the reference image embedding 408 with the text embeddings 402 and the noisy tokens 410 to form the set of input tokens 412. For instance, the layered design generation system 106 concatenates the text embeddings 402, the reference image embedding 408, and the noisy tokens 410 in a sequence determined according to training/finetuning of a diffusion neural network. The layered design generation system 106 utilizes the set of input tokens 412 to represent descriptions, features, and characteristics of a target digital design (e.g., the target digital design 210 of FIG. 2).

As mentioned, in one or more embodiments, the layered design generation system 106 utilizes a diffusion neural network to generate a target digital design. FIG. 5 illustrates a diagram of the layered design generation system 106 utilizing a diffusion neural network to generate a plurality of design layers to form a target digital design.

As illustrated in FIG. 5, the layered design generation system 106 feeds a set of input tokens 502 into a diffusion neural network 504. In particular, the layered design generation system 106 utilizes the diffusion neural network 504 to denoise the set of input tokens 502, including one or more noisy tokens (e.g., the noisy tokens 410 of FIG. 4). In one or more embodiments, the layered design generation system 106 utilizes the diffusion neural network 504 to process the set of input tokens 502 as a multi-step process of generating denoised tokens, wherein the diffusion neural network 504 iteratively generates a denoised target digital design. In one or more embodiments, the layered design generation system 106 instructs the diffusion neural network 504 to generate all denoised tokens in a single denoising process to capture the structural dependencies of the elements described in a prompt (e.g., the description 302 of FIG. 3).

As further illustrated in FIG. 5, the layered design generation system 106 generates design layers 506 via the diffusion neural network 504. In particular, the layered design generation system 106 generates the design layers 506 by defining a digital design element type (e.g., background, shape, text, image, vector) for each digital design element generated by the diffusion neural network 504. For example, the layered design generation system 106, when generating a poster for a Halloween costume contest, generates separate layers showing a spooky background, lettering describing a costume contest, and several bat shapes. To illustrate, the layered design generation system 106 trains or finetunes the diffusion neural network 504 to generate separate layers for separate digital design element types. For example, the layered design generation system 106 groups certain types of digital design elements into a single design layer to prevent creation of many sparse layers, which may cause the generated content to exceed a frame budget. In one or more embodiments, the layered design generation system 106 utilizes the diffusion neural network 504 to group together non-overlapping digital design elements of the same type to compose them into the design layers 506.

In one or more embodiments, the layered design generation system 106 groups certain digital design elements (e.g., text) together regardless of overlap to form a design layer within the design layers 506. For instance, the layered design generation system 106 groups certain overlapping elements together based on common practices, such as if a single shape is composed of different pieces (e.g., elements) of the same color, if text has certain font effects (e.g., shadows), or based on a percentage/proportion of overlap relative to a threshold. Thus, the layered design generation system 106 determines (e.g., utilizing the diffusion neural network 504) whether to group certain digital design elements together in a single design layer or to separate the elements into separate design layers depending on the specific types or other attributes of the elements.

As further illustrated in FIG. 5, the layered design generation system 106 utilizes the design layers 506 to generate a target digital design 508. In particular, the layered design generation system 106 generates the target digital design 508 by arranging the design layers 506 or elements in the design layers 506 to form the target digital design 508 corresponding to a description of a text description of the target digital design 508. Additionally, the layered design generation system 106 utilizes the diffusion neural network 504 to generate the target digital design 508 according to the one or more categorical parameters (e.g., arranging the one or more layers to form a poster for a Halloween costume contest in a spooky theme). In one or more embodiments, the layered design generation system 106 generates the target digital design 508 at a lower resolution (e.g., 512 pixels) and utilizing a convolutional neural network upsampler to increase the resolution of the target digital design 508.

In one or more embodiments, the layered design generation system 106 generates the target digital design 508 so that the individual digital design elements within the target digital design 508 are individually selectable and editable. In some embodiments, the layered design generation system 106 modifies the digital design elements in the design layers 506 for editing via a particular editing application. For example, the layered design generation system 106 modifies one or more design layers by converting certain elements from raster elements (e.g., according to an output of the diffusion neural network 504) to vector elements, by modifying boundaries of certain elements, or by changing properties of certain elements.

For example, for a design layer including text digital design elements, the layered design generation system 106 utilizes a font detection model to detect the text digital design elements and transform the text digital design elements into editable text elements including certain text elements (e.g., font, size, color). To illustrate, the layered design generation system 106 associates a closest available font (e.g., via font recognition processes) to the generated pixels. Additionally, the layered design generation system 106 generates a bounding box in a layer following a design layer including text to indicate the location and font of the text for optical character recognition and extraction of the text as an editable text element. To illustrate, the layered design generation system 106 extracts the pixels of the design layer including text elements for a given bounding box and performs optical character recognition on the text while utilizing a text matching algorithm to assign the appropriate text/font to the corresponding bounding box. The layered design generation system 106 provides the extracted information to a text renderer to render the text as editable text elements.

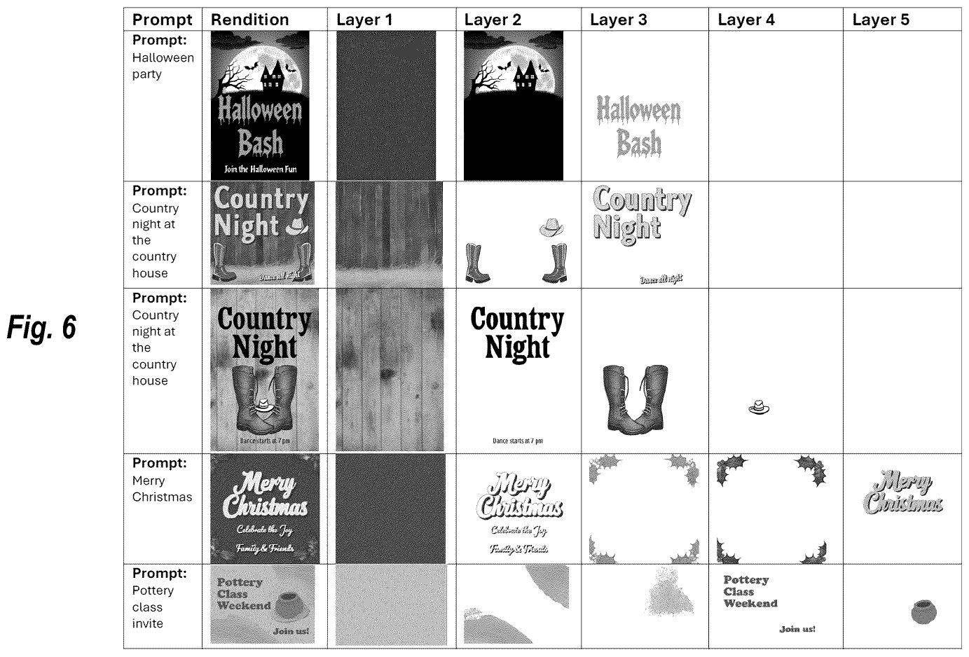

As mentioned, in one or more embodiments, the layered design generation system 106 generates target digital designs with a plurality of digital design layers. FIG. 6 illustrates example digital designs with corresponding digital design layers.

As illustrated in FIG. 6, the layered design generation system 106 generates target digital designs according to a text description. For example, the layered design generation system 106, when prompted with the description “Halloween party,” generates a poster for a Halloween party, incorporating elements such as a haunted house, bats, and orange lettering. Further, the layered design generation system 106 generates the poster by generating three design layers including a gray background layer, a layer of images composing a haunted house with bats flying overhead, and a text layer of the orange text.

As further illustrated in FIG. 6, the layered design generation system 106 generates multiple composed digital designs based on a text description. For example, in response to the description “country night at the country house,” the layered design generation system 106 generates two alternative versions of a poster for a country night, with each poster version including a different number of layers corresponding with the different digital design elements used to compose the alternative poster versions.

As further illustrated in FIG. 6, the layered design generation system 106 generates different numbers of layers depending on the prompt and the composition of the target digital design. For example, the layered design generation system 106, in response to being prompted with the description “Merry Christmas,” generates a Christmas card made up of five design layers. As depicted, the layered design generation system 106 generates a red background layer, a first text layer with a text base layer, a holly base layer, a holly image layer, and a colored text layer to compose the Christmas card.

As further illustrated in FIG. 6, the layered design generation system 106 overlays different layers to create a composed digital design. For example, the layered design generation system 106, in response to a description of a “pottery class invite,” generates three overlapping brown layers to mimic the appearance of sculpted clay. Further, the layered design generation system 106 generates text for the initiation and a graphic of a pottery bowl

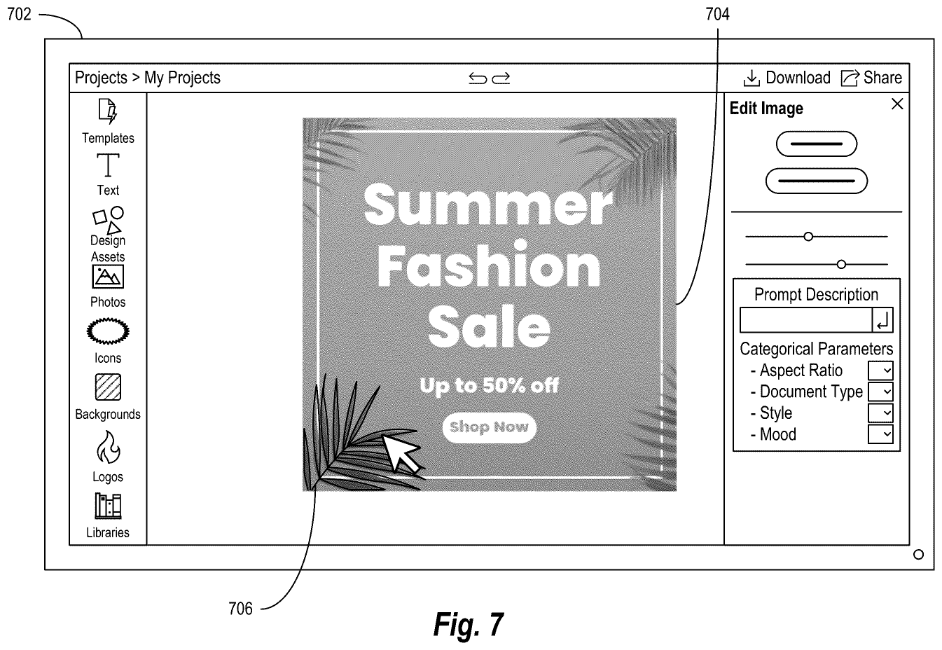

As mentioned, in one or more embodiments, the layered design generation system 106 generates an editable target digital design for display. FIG. 7 illustrates an example graphical user interface (“GUI”) presenting a target digital design to a client device interacting with an element of the presented target digital design.

As illustrated in FIG. 7, the layered design generation system 106 presents a target digital design 704 on a GUI 702. For example, the GUI 702 includes various options for a client device to interact with the target digital design 704, such as resizing, cropping, inserting digital design elements, and removing digital design elements. As part of the GUI 702, the layered design generation system 106 presents a text field for entering a prompt description and one or more drop down fields for categorical parameters. In particular, the layered design generation system 106 generates and presents the target digital design 704 to the client device in response to the client device receiving a prompt in the text field describing the target digital design 704 and selecting one or more categorical parameters. In one or more embodiments, the layered design generation system 106 generates the target digital design 704 (e.g., utilizing the encoder neural network(s) and diffusion neural network described previously) with several interactable digital design elements arranged to form a coherent digital design.

As further illustrated in FIG. 7, the layered design generation system 106 presents an interactable digital design element 706 as part of the target digital design 704. In particular, the layered design generation system 106, in response to a client device interaction with the interactable digital design element 706 (e.g., clicking the interactable digital design element 706), updates the target digital design 704 for display on the GUI 702 (e.g., outlining the interactable digital design element 706). In one or more embodiments, the layered design generation system 106 updates the target digital design 704 after a client device interaction moving, removing, or otherwise modifying the interactable digital design element 706.

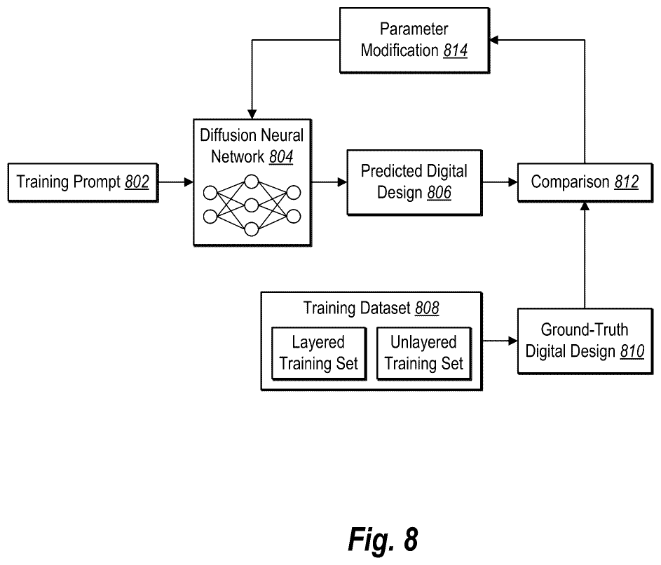

As mentioned, in one or more embodiments, the layered design generation system 106 trains a diffusion neural network to generate target digital designs. FIG. 8 illustrates an example diagram of utilizing a training dataset to train or finetune a diffusion neural network to generate predicted digital designs in accordance with one or more embodiments.

As illustrated in FIG. 8, the layered design generation system 106 provides a training prompt 802 to a diffusion neural network 804. In particular, the training prompt 802 describes a target digital design for the diffusion neural network 804 to generate. In one or more embodiments, the layered design generation system 106 leverages the diffusion neural network 804 to generate a predicted digital design 806 depicting the target digital design described by the training prompt 802.

As further illustrated in FIG. 8, the layered design generation system 106 accesses a training dataset 808. In particular, the training dataset 808 includes both a layered training set and an unlayered training set. In one or more embodiments, the layered design generation system 106 generates the layered training set to include digital designs with structure and digital design elements split into design layers according to digital design element types. In certain embodiments, the layered design generation system 106 generates the layered training set by setting a layer budget (e.g., a specified number of layers), identifying sample layered digital designs with a number of layers less than the layer budget, and appending zero-frame layers to the identified sample layered digital design to reach the layer budget. Further, the layered design generation system 106 utilizes the unlayered training set to train the diffusion neural network 804 to generate digital designs that look cohesive while boosting the quality of generated target digital designs. In some embodiments, the layered design generation system 106 combines the layered training set and unlayered training set in a single training process to prevent the diffusion neural network 804 from forgetting design aspects (e.g., multi-layer design structure or single-layer designs) represented by either set.

As further illustrated in FIG. 8, the layered design generation system 106 selects a ground-truth digital design 810 corresponding to the training prompt 802. For example, the ground-truth digital design 810 depicts a digital design described the training prompt 802. In one or more embodiments, the layered design generation system 106 performs a comparison 812 between the predicted digital design 806 and the ground-truth digital design 810. In one or more embodiments, the layered design generation system 106 performs the comparison 812 to determine differences between the predicted digital design 806 and the ground-truth digital design 810. In certain embodiments, the layered design generation system 106 performs the comparison 812 by calculating a loss value between the ground-truth digital design 810 and the predicted digital design 806.

As further illustrated in FIG. 8, the layered design generation system 106, based on the comparison 812, performs a parameter modification 814 to train the diffusion neural network 804. In particular, the layered design generation system 106 uses the parameter modification 814 to improve the ability of the diffusion neural network 804 to generate the predicted digital design 806 to match the ground-truth digital design 810 based on the training dataset 808.

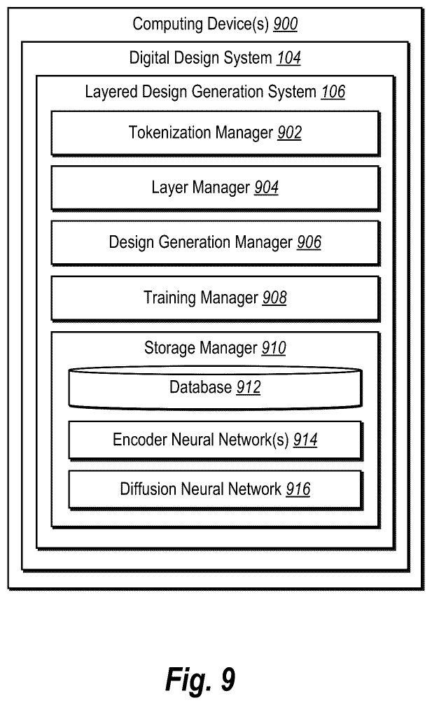

Referring now to FIG. 9, additional detail will be provided regarding components and capabilities of the layered design generation system 106. Specifically, FIG. 9 illustrates an example schematic diagram of the layered design generation system 106 on an example computing device(s) 900 (e.g., one or more of the client device 116 and/or the server device(s) 102). As shown in FIG. 9, the layered design generation system 106 includes a tokenization manager 902, a layer manager 904, a design generation manager 906, a training manager, and a storage manager 910.

As mentioned, the layered design generation system 106 includes a tokenization manager 902. In particular, the tokenization manager 902 generates, modifies, alters, or selects one or more tokens (e.g., the set of input tokens 412 of FIG. 4). For example, the tokenization manager 902 generates embeddings representing a text description, one or more categorical parameter selections, and a reference digital design.

As mentioned, the layered design generation system 106 includes a layer manager 904. In particular, the layer manager 904 generates, modifies, alters, or arranges one or more design layers (e.g., the design layers 506 of FIG. 5). For example, the layer manager 904 utilizes a diffusion neural network to generate a plurality of design layers, with each layer composed of one type of digital design element.

As mentioned, the layered design generation system 106 includes a design generation manager 906. In particular, the design generation manager 906 generates, modifies, alters, or presents a target digital design (e.g., the target digital design 508 of FIG. 5). For example, the design generation manager 906 generates a target digital design composed of, or generated from, design layers according to a text description of the target digital design.

As mentioned, the layered design generation system 106 includes a training manager 908. In particular, the training manager 908 trains a diffusion neural network (e.g., the diffusion neural network 916) to generate target digital designs. For example, the training manager accesses a training dataset (e.g., the training dataset 808) and trains the diffusion neural network to predict a digital design. In additional embodiments, the training manager 908 generates both a layered training set and an unlayered training set to train the diffusion neural network.

The layered design generation system 106 further includes a storage manager 910. The storage manager 910 operates in conjunction with the other components of the layered design generation system 106 and includes one or more memory devices such as the database 912 (e.g., the database 114) that stores various data such as reference layered digital designs, reference unlayered digital designs, text prompts, reference digital designs, and ground-truth digital designs. In some cases, the storage manager 910 also manages or maintains an encoder neural network(s) 914 and a diffusion neural network 916 for generating target digital designs using one or more components of the layered design generation system 106 as described above.

In one or more embodiments, each of the components of the layered design generation system 106 are in communication with one another using any suitable communication technologies. Additionally, the components of the layered design generation system 106 are in communication with one or more other devices including one or more client devices described above. It will be recognized that although the components of the layered design generation system 106 are shown to be separate in FIG. 9, any of the subcomponents may be combined into fewer components, such as into a single component, or divided into more components as may serve a particular implementation. Furthermore, although the components of FIG. 9 are described in connection with the layered design generation system 106, at least some of the components for performing operations in conjunction with the layered design generation system 106 described herein may be implemented on other devices within the environment.

The components of the layered design generation system 106 include software, hardware, or both. For example, the components of the layered design generation system 106 include one or more instructions stored on a computer-readable storage medium and executable by processors of one or more computing devices (e.g., the computing device(s) 900). When executed by the one or more processors, the computer-executable instructions of the layered design generation system 106 cause the computing device(s) 900 to perform the methods described herein. Alternatively, the components of the layered design generation system 106 comprise hardware, such as a special purpose processing device to perform a certain function or group of functions. Additionally, or alternatively, the components of the layered design generation system 106 include a combination of computer-executable instructions and hardware.

Furthermore, the components of the layered design generation system 106 performing the functions described herein may, for example, be implemented as part of a stand-alone application, as a module of an application, as a plug-in for applications including content management applications, as a library function or functions that may be called by other applications, and/or as a cloud-computing model. Thus, the components of the layered design generation system 106 may be implemented as part of a stand-alone application on a personal computing device or a mobile device. Alternatively, or additionally, the components of the layered design generation system 106 may be implemented in any application that allows creation and delivery of content to users, including, but not limited to, ADOBE® applications such as ADOBE® EXPRESS® and ADOBE® FIREFLY®. “ADOBE,” “EXPRESS,” and “FIREFLY” are either registered trademarks or trademarks of Adobe Inc. in the United States and/or other countries.

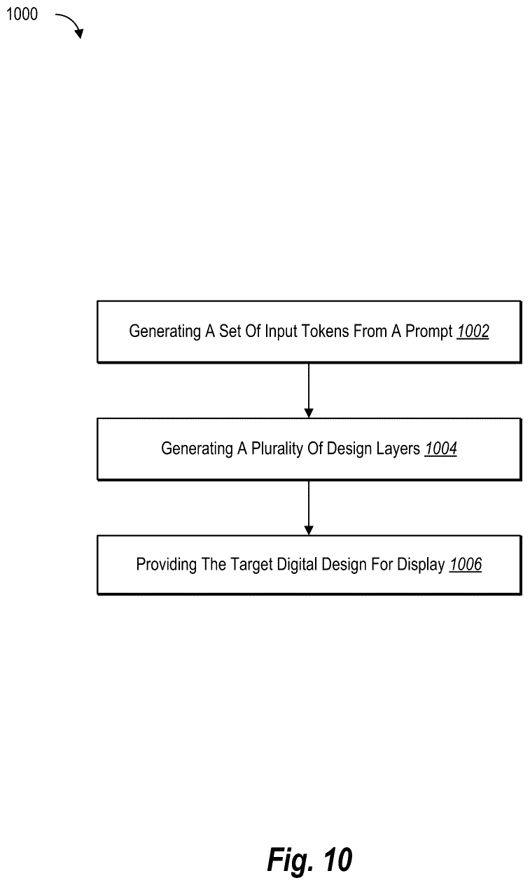

FIGS. 1-9, the corresponding text, and the examples provide a number of different systems, methods, and non-transitory computer readable media for generating a target digital design from a description of the target digital design. In addition to the foregoing, embodiments can also be described in terms of flowcharts comprising acts for accomplishing a particular result. For example, FIG. 10 illustrates a flowchart of example sequences or series of acts in accordance with one or more embodiments.

While FIG. 10 illustrates acts according to particular embodiments, alternative embodiments may omit, add to, reorder, and/or modify any of the acts shown in FIG. 10. The acts of FIG. 10 can be performed as part of a method. Alternatively, a non-transitory computer readable medium can comprise instructions that, when executed by one or more processors, cause a computing device to perform the acts of FIG. 10. In still further embodiments, a system can perform the acts of FIG. 10. Additionally, the acts described herein may be repeated or performed in parallel with different instances of the same or other similar acts.

FIG. 10 illustrates an example series of acts 1000 for generating a target digital design. In particular, the series of acts 1000 includes an act 1002 of generating a set of input tokens from a prompt. For example, the act 1002 involves generating, utilizing one or more encoder neural networks, a set of input tokens from a prompt comprising a description of a target digital design and one or more categorical parameters for the target digital design. Further, the series of acts 1000 includes an act 1004 of generating a plurality of design layers. For example, the act 1004 generating, utilizing a diffusion neural network and based on the set of input tokens, a plurality of design layers including digital design elements according to the description of the target digital design. Further, the series of acts 1000 includes an act 1006 of providing the target digital design for display. For example, the act 1006 involves providing, for display within a digital design application of a client device, the target digital design having document attributes corresponding to the one or more categorical parameters and comprising the digital design elements of the plurality of design layers as separately interactive elements.

In some embodiments, the series of acts 1000 includes generating an expanded description by prompting a large language model to generate additional details related to the description of the target digital design. The series of acts 1000 also includes providing, to the client device, a set of selectable categorical parameters. The series of acts 1000 also includes determining the one or more categorical parameters for the target digital design in response to one or more selections from the set of selectable categorical parameters via the client device. The series of acts 1000 also includes determining the one or more categorical parameters by generating a prompt to cause a large language model to extract the one or more categorical parameters from the description of the target digital design.

In some embodiments, the series of acts 1000 includes generating, utilizing an encoder neural network, an image embedding from a reference digital design. The series of acts 1000 also includes generating, based on a client device interaction, a layer number embedding representing a target number of design layers for the target digital design. The series of acts 1000 also includes combining the image embedding with a prompt embedding representing the prompt and a layer number embedding in the set of input tokens.

In some embodiments, the series of acts 1000 includes generating a design layer of the plurality of design layers comprising: a background design layer including a background digital design element; a shape design layer including a vectorial digital design element; a text design layer including a text digital design element; or an image design layer including an image digital design element. The series of acts 1000 also includes determining digital design element types for a plurality of digital design elements generated utilizing the diffusion neural network. The series of acts 1000 also includes identifying one or more non-overlapping digital design elements sharing a digital design element type. The series of acts 1000 also includes generating the design layer according to the digital design element type of the one or more non-overlapping digital design elements.

In some embodiments, the series of acts 1000 includes identifying the design layer within the plurality of design layers as a text design layer. The series of acts 1000 also includes transforming the one or more non-overlapping digital design elements within the text design layer into editable text digital design elements.

In some embodiments, the series of acts 1000 includes generating a modified target digital design in response to one or more client device interactions with an interactive element of the separately interactive elements of the target digital design. The series of acts 1000 also includes providing the modified target digital design for display within the digital design application of the client device. The series of acts 1000 also includes generating, utilizing the diffusion neural network, an initial digital design comprising the plurality of design layers at a first resolution. The series of acts 1000 also includes generating, by upsampling the initial digital design, the target digital design at a second resolution higher than the first resolution.

In some embodiments, the series of acts 1000 includes determining, in response to a text input via a client device, a text prompt comprising a natural language description of a target digital design. The series of acts 1000 also includes determining, in response to one or more parameter selections via the client device, a condition prompt comprising one or more categorical parameters for the target digital design. The series of acts 1000 also includes generating, utilizing one or more encoder neural networks, a set of input tokens from the text prompt and the condition prompt. The series of acts 1000 also includes generating, utilizing a diffusion neural network and based on the set of input tokens, a plurality of design layers including digital design elements of different element types according to the natural language description of the target digital design. The series of acts 1000 also includes providing, for display within a digital design application of a client device, the target digital design having document attributes corresponding to the one or more categorical parameters and comprising the digital design elements of the plurality of design layers as separately interactive elements.

In some embodiments, the series of acts 1000 includes generating, utilizing a large language model in response to determining the text prompt from the text input via the client device, an expanded description comprising additional details related to the natural language description of the target digital design. The series of acts 1000 also includes determining a reference digital design comprising a style for conditioning the diffusion neural network. The series of acts 1000 also includes combining embeddings representing the expanded description, the condition prompt, the reference digital design, and a plurality of noisy tokens in the set of input tokens.

In some embodiments, the series of acts 1000 includes determining a target number of design layers for the target digital design. The series of acts 1000 also includes generating, utilizing the one or more encoder neural networks, a layer number embedding representing the target number of design layers. The series of acts 1000 also includes including the layer number embedding in the set of input tokens.

In some embodiments, the series of acts 1000 includes determining digital design element types for the digital design elements of the plurality of design layers. The series of acts 1000 also includes determining design layer types for the plurality of design layers based on the digital design element types. The series of acts 1000 also includes arranging the design layers within the plurality of design layers according to the design layer types.

In some embodiments, the series of acts 1000 includes providing one or more selectable categorical parameters to the client device including a document type parameter, an aspect ratio parameter, a style parameter, or a mood parameter. The series of acts 1000 also includes determining the condition prompt based on a client device selection of the one or more selectable categorical parameters.

In one or more embodiments, the series of acts 1000 includes generating, utilizing one or more encoder neural networks, a set of input tokens from a prompt comprising a description of a target digital design and one or more categorical parameters for the target digital design. The series of acts 1000 also includes generating, utilizing a diffusion neural network and based on the set of input tokens, a plurality of design layers including digital design elements according to the description of the target digital design. The series of acts 1000 also includes providing, for display within a digital design application of a client device, the target digital design having document attributes corresponding to the one or more categorical parameters and comprising the digital design elements of the plurality of design layers as separately interactive elements.

In one or more embodiments, the series of acts 1000 includes generating, utilizing a large language model, an expanded description of the target digital design from the description of the target digital design. The series of acts 1000 also includes generating the one or more categorical parameters for the target digital design by inferring the one or more categorical parameters from the description of the target digital design. The series of acts 1000 also includes determining a reference digital design including a target style for the target digital design. The series of acts 1000 also includes determining a target number of design layers for the target digital design. The series of acts 1000 also includes generating the set of input tokens by combining embeddings representing the expanded description, the one or more categorical parameters, the reference digital design, and the target number of design layers with a plurality of noisy tokens.

In one or more embodiments, the series of acts 1000 includes determining design layer types of the plurality of design layers based on digital design element types of the digital design elements of the plurality of design layers. The series of acts 1000 also includes arranging the plurality of design layers according to design layer types of the plurality of design layers.

In one or more embodiments, the series of acts 1000 includes generating a layered training set by labeling one or more design layers within a set of sample layered digital designs. The series of acts 1000 also includes generating an unlayered training set from a set of sample unlayered digital designs. The series of acts 1000 also includes adjusting parameters of the diffusion neural network to generate target digital designs including layered data in a hybrid training process utilizing the layered training set and the unlayered training set. The series of acts 1000 also includes determining a target number of design layers for the set of sample layered digital designs. The series of acts 1000 also includes identifying one or more sample layered digital designs with a number of design layers less than the target number of design layers. The series of acts 1000 also includes padding the one or more sample layered digital designs with one or more zero-frame layers until reaching the target number of design layers.

### Architecture: Pixel Diffusion

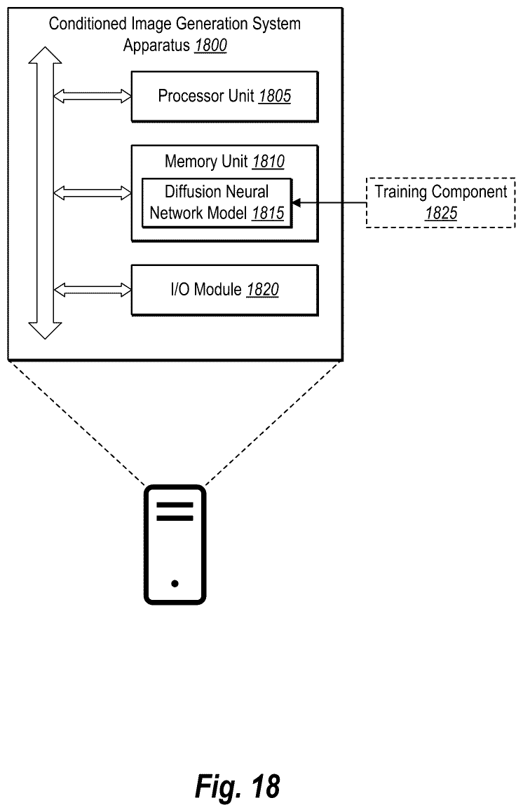

FIG. 11 shows an example of a guided diffusion model 1100 according to aspects of the present disclosure. In some examples, guided diffusion model 1100 describes the operation and architecture of the diffusion neural network model 1815 described with reference to FIG. 18. The guided diffusion model 1100 depicted in FIG. 11 is an example of, or includes aspects of, a media generation model as described herein.

Diffusion models are a class of generative neural networks which can be trained to generate new data with features similar to features found in training data. In particular, diffusion models can be used to generate novel media items such as images, audio files, videos, three-dimensional (3D) models or other digital media items. Diffusion models can be used for various media processing tasks including image super-resolution, generation of media items with perceptual metrics, conditional generation (e.g., generation based on text guidance), image inpainting, and media manipulation.

Diffusion models work by iteratively adding noise to the data during a forward process and then learning to recover the data by denoising the data during a reverse process. For example, during training, guided diffusion model 1100 may take an original media item 1105 in a pixel space 1110 as input and apply forward diffusion process 1115 to gradually add noise to the original media item 1105 to obtain noisy media item 1120 at various noise levels.

Next, a reverse diffusion process 1125 (e.g., a U-Net) gradually removes the noise from the noisy media item 1120 at the various noise levels to obtain an output media item 1130. In some cases, an output media item 1130 is created from each of the various noise levels. The output media item 1130 can be compared to the original media item 1105 to train the reverse diffusion process 1125.

The reverse diffusion process 1125 can also be guided based on a text prompt 1135, or another guidance prompt, such as an image, a layout, a segmentation map, etc. The text prompt 1135 can be encoded using a text encoder 1140 (e.g., a multimodal encoder) to obtain guidance features 1145 in guidance space 1150. The guidance features 1145 can be combined with the noisy media item 1120 at one or more layers of the reverse diffusion process 1125 to ensure that the output media item 1130 includes content described by the text prompt 1135. For example, guidance features 1145 can be combined with the noisy features using a cross-attention block within the reverse diffusion process 1125.

Methods of operating diffusion models include a Denoising Diffusion Probabilistic Model (DDPM) and a Denoising Diffusion Implicit Models (DDIM). In DDPM, the generative process includes reversing a stochastic Markov diffusion process. DDIMs, on the other hand, use a deterministic process so that the same input results in the same output. In some cases, DDIM can reduce the number of timesteps during media generation. Diffusion models may also be characterized by whether the noise is added to the media item itself, or to media features generated by an encoder (i.e., latent diffusion). In a pixel diffusion model, noise is added and removed in pixel space. In a latent diffusion model, the noise is added (and removed) in a latent space of media features rather than in pixel space. Thus, a latent diffusion model generates media features using reverse diffusion, and these media features can be decoded to obtain a synthetic media item.

### Architecture: U-Net

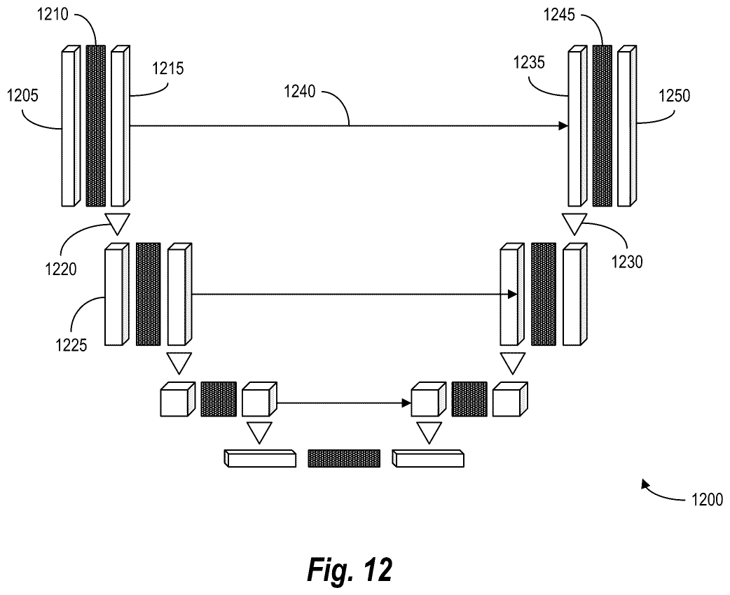

FIG. 12 shows an example of a U-Net 1200 according to aspects of the present disclosure. In some examples, U-Net 1200 is an example of the component that performs the reverse diffusion process 1125 of guided diffusion model 1100 described with reference to FIG. 11 and includes architectural elements of the diffusion neural network model 1815 described with reference to FIG. 18. The U-Net 1200 depicted in FIG. 12 is an example of, or includes aspects of, the architecture used within the reverse diffusion process described with reference to FIG. 11.

In some examples, diffusion models are based on a neural network architecture known as a U-Net. The U-Net 1200 takes input features 1205 having an initial resolution and an initial number of channels and processes the input features 1205 using an initial neural network layer 1210 (e.g., a convolutional network layer) to produce intermediate features 1215. The intermediate features 1215 are then down-sampled using a down-sampling layer 1220 such that down-sampled features 1225 features have a resolution less than the initial resolution and a number of channels greater than the initial number of channels.

This process is repeated multiple times, and then the process is reversed. That is, the down-sampled features 1225 are up-sampled using up-sampling process 1230 to obtain up-sampled features 1235. The up-sampled features 1235 can be combined with intermediate features 1215 having the same resolution and number of channels via a skip connection 1240. These inputs are processed using a final neural network layer 1245 to produce output features 1250. In some cases, the output features 1250 have the same resolution as the initial resolution and the same number of channels as the initial number of channels.

In some cases, U-Net 1200 takes additional input features to produce conditionally generated output. For example, the additional input features could include a vector representation of an input prompt. The additional input features can be combined with the intermediate features 1215 within the neural network at one or more layers. For example, a cross-attention module can be used to combine the additional input features and the intermediate features 1215.

### Inference: Conditional Generation

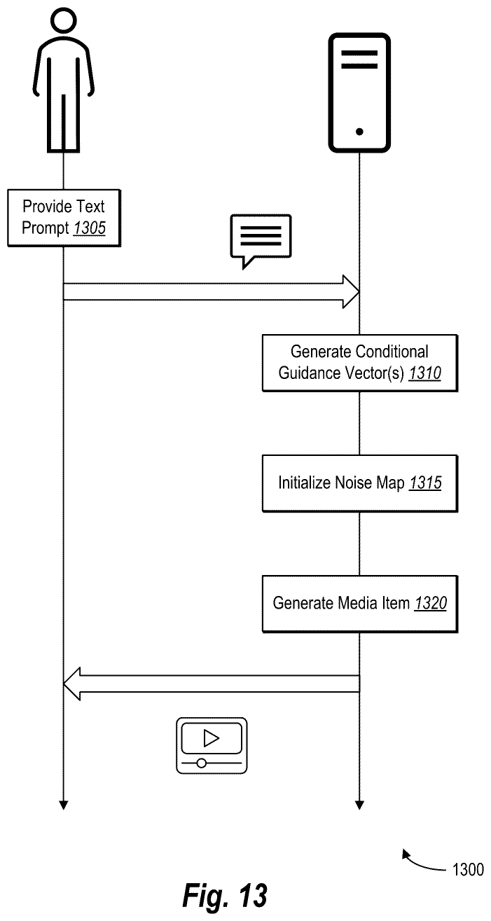

FIG. 13 shows an example of a method 1300 for conditional media generation according to aspects of the present disclosure. In some examples, method 1300 describes an operation of the diffusion neural network model 1815 described with reference to FIG. 18 such as an application of the guided diffusion model 1100 described with reference to FIG. 11. In some examples, these operations are performed by a system including a processor executing a set of codes to control functional elements of an apparatus such as the media generation model described in FIG. 11.

Additionally or alternatively, steps of the method 1300 may be performed using special-purpose hardware. Generally, these operations are performed according to the methods and processes described in accordance with aspects of the present disclosure. In some cases, the operations described herein are composed of various substeps, or are performed in conjunction with other operations.

At operation 1305, a user provides a text prompt describing content to be included in a generated media item. For example, a user may provide the prompt “a person playing with a cat”. In some examples, guidance can be provided in a form other than text, such as via an image, a sketch, or a layout.

At operation 1310, the system converts the text prompt (or other guidance) into a conditional guidance vector or other multi-dimensional representation. For example, text may be converted into a vector or a series of vectors using a transformer model, or a multi-modal encoder. In some cases, the encoder for the conditional guidance is trained independently of the diffusion model.

At operation 1315, a noise map is initialized that includes random noise. The noise map may be in a pixel space or a latent space. By initializing a media item with random noise, different variations of a media item including the content described by the conditional guidance can be generated.

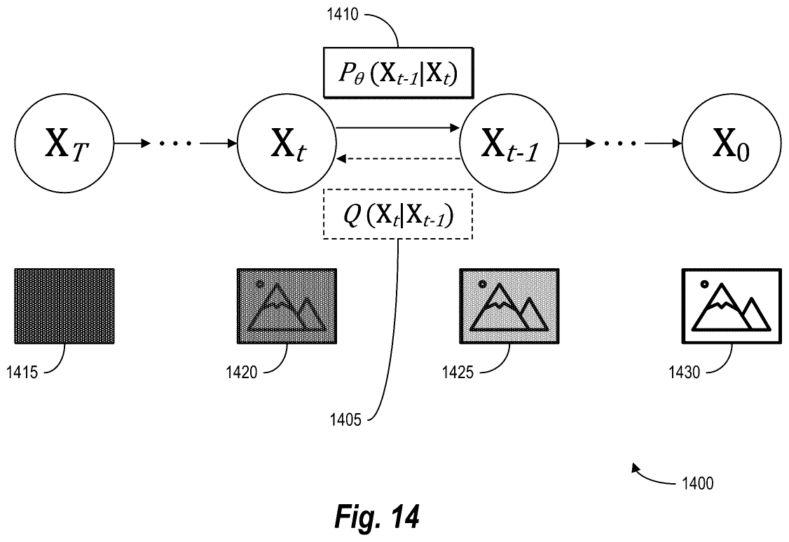

At operation 1320, the system generates a media item based on the noise map and the conditional guidance vector. For example, the media item may be generated using a reverse diffusion process as described with reference to FIG. 14.

### Inference: Reverse Diffusion

FIG. 14 shows a diffusion process 1400 according to aspects of the present disclosure. In some examples, diffusion process 1400 describes an operation of the diffusion neural network model 1815 described with reference to FIG. 18, such as the reverse diffusion process 1125 of guided diffusion model 1100 described with reference to FIG. 11.

As described above with reference to FIG. 11, using a diffusion model can involve both a forward diffusion process 1405 for adding noise to a media item (or features in a latent space) and a reverse diffusion process 1410 for denoising the media item (or features) to obtain a denoised media item. The forward diffusion process 1405 can be represented as q(xₜ|xₜ₋₁), and the reverse diffusion process 1410 can be represented as p(xₜ₋₁|xₜ). In some cases, the forward diffusion process 1405 is used during training to generate media items with successively greater noise, and a neural network is trained to perform the reverse diffusion process 1410 (i.e., to successively remove the noise).

In an example forward process for a latent diffusion model, the model maps an observed variable x₀ (either in a pixel space or a latent space) intermediate variables x₁, . . . , x_{T} using a Markov chain. The Markov chain gradually adds Gaussian noise to the data to obtain the approximate posterior q(x_{1:T}|x₀) as the latent variables are passed through a neural network such as a U-Net, where x₁, . . . , x_{T} have the same dimensionality as x₀.

The neural network may be trained to perform the reverse process. During the reverse diffusion process 1410, the model begins with noisy data x_{T}, such as a noisy media item 1415 and denoises the data to obtain the p(xₜ₋₁|xₜ). At each step t−1, the reverse diffusion process 1410 takes xₜ, such as first intermediate media item 1420, and t as input. Here, t represents a step in the sequence of transitions associated with different noise levels, The reverse diffusion process 1410 outputs xₜ₋₁, such as second intermediate media item 1425 iteratively until x_{T} reverts back to x₀, the original media item 1430. The reverse process can be represented as:

p_{θ}(xₜ₋₁|xₜ): =N(xₜ₋₁;μ_{θ}(xₜ,t),Σ_{θ}(xₜ,t)). (1)

The joint probability of a sequence of samples in the Markov chain can be written as a product of conditionals and the marginal probability:

$${x}_{T} : {p}_{θ} ( {x}_{0 : T} ) := p ( {x}_{T} ) {\prod }_{t = 1}^{T} {p}_{θ} ( {x}_{t - 1} \vert {x}_{t} ) , \qquad ( 2 )$$

where p(x_{T})=N(x_{T}; 0, I) is the pure noise distribution as the reverse process takes the outcome of the forward process, a sample of pure noise, as input and

$${\prod }_{t = 1}^{T} {p}_{θ} ( {x}_{t - 1} \vert {x}_{t} )$$

represents a sequence of Gaussian transitions corresponding to a sequence of addition of Gaussian noise to the sample.

At interference time, observed data x₀ in a pixel space can be mapped into a latent space as input and a generated data \tilde{x} is mapped back into the pixel space from the latent space as output. In some examples, x₀ represents an original input media item with low quality, latent variables x₁, . . . , x_{T} represent noisy media items, and x represents the generated item with high quality.

### Training: Machine Learning

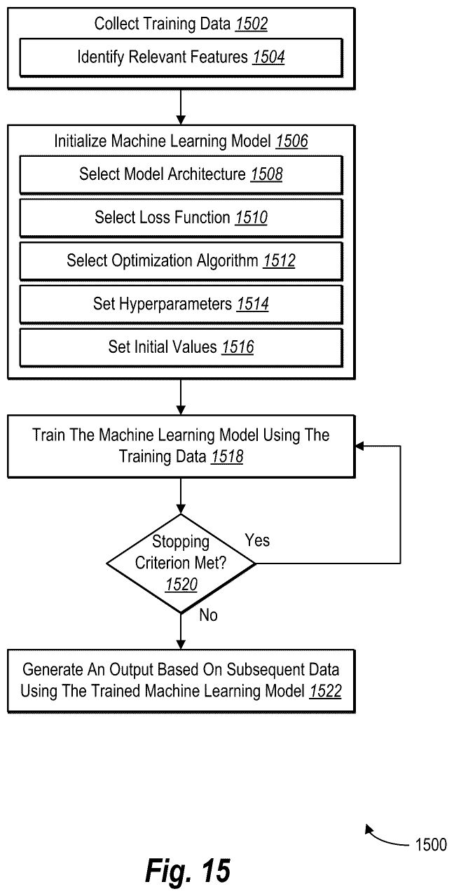

FIG. 15 is a flow diagram depicting an algorithm as a step-by-step procedure 1500 in an example implementation of operations performable for training a machine-learning model. In some embodiments, the step-by-step procedure 1500 describes an operation of the training component 1825 described for configuring the diffusion neural network model 1815 as described with reference to FIG. 18. The step-by-step procedure 1500 provides one or more examples of generating training data, use of the training data to train a machine-learning model, and use of the trained machine-learning model to perform a task.

To begin in this example, a machine-learning system collects training data (block 1502) that is to be used as a basis to train a machine-learning model, i.e., which defines what is being modeled. The training data is collectable by the machine-learning system from a variety of sources. Examples of training data sources include public datasets, service provider system platforms that expose application programming interfaces (e.g., social media platforms), user data collection systems (e.g., digital surveys and online crowdsourcing systems), and so forth. Training data collection may also include data augmentation and synthetic data generation techniques to expand and diversify available training data, balancing techniques to balance a number of positive and negative examples, and so forth.

The machine-learning system is also configurable to identify features that are relevant (block 1504) to a type of task, for which the machine-learning model is to be trained. Task examples include classification, natural language processing, generative artificial intelligence, recommendation engines, reinforcement learning, clustering, and so forth. To do so, the machine-learning system collects the training data based on the identified features and/or filters the training data based on the identified features after collection. The training data is then utilized to train a machine-learning model.

In order to train the machine-learning model in the illustrated example, the machine-learning model is first initialized (block 1506). Initialization of the machine-learning model includes selecting a model architecture (block 1508) to be trained. Examples of model architectures include neural networks, convolutional neural networks (CNNs), long short-term memory (LSTM) neural networks, generative adversarial networks (GANs), decision trees, support vector machines, linear regression, logistic regression, Bayesian networks, random forest learning, dimensionality reduction algorithms, boosting algorithms, deep learning neural networks, etc.

A loss function is also selected (block 1510). The loss function is utilized to measure a difference between an output of the machine-learning model (i.e., predictions) and target values (e.g., as expressed by the training data) to be used to train the machine-learning model. Additionally, an optimization algorithm is selected (1512) that is to be used in conjunction with the loss function to optimize parameters of the machine-learning model during training, examples of which include gradient descent, stochastic gradient descent (SGD), and so forth.

Initialization of the machine-learning model further includes setting initial values of the machine-learning model (block 1516) examples of which includes initializing weights and biases of nodes to improve efficiency in training and computational resources consumption as part of training. Hyperparameters are also set (block 1514) that are used to control training of the machine learning model, examples of which include regularization parameters, model parameters (e.g., a number of layers in a neural network), learning rate, batch sizes selected from the training data, and so on. The hyperparameters are set using a variety of techniques, including use of a randomization technique, through use of heuristics learned from other training scenarios, and so forth.

The machine-learning model is then trained using the training data (block 1518) by the machine-learning system. A machine-learning model refers to a computer representation that can be tuned (e.g., trained and retrained) based on inputs of the training data to approximate unknown functions. In particular, the term machine-learning model can include a model that utilizes algorithms (e.g., using the model architectures described above) to learn from, and make predictions on, known data by analyzing training data to learn and relearn to generate outputs that reflect patterns and attributes expressed by the training data.

Examples of training types include supervised learning that employs labeled data, unsupervised learning that involves finding an underlying structures or patterns within the training data, reinforcement learning based on optimization functions (e.g., rewards and/or penalties), use of nodes as part of “deep learning,” and so forth. The machine-learning model, for instance, is configurable as including a plurality of nodes that collectively form a plurality of layers. The layers, for instance, are configurable to include an input layer, an output layer, and one or more hidden layers. Calculations are performed by the nodes within the layers through the hidden states through a system of weighted connections that are “learned” during training, e.g., through use of the selected loss function and backpropagation to optimize performance of the machine-learning model to perform an associated task.

As part of training the machine-learning model, a determination is made as to whether a stopping criterion is met (decision block 1520), i.e., which is used to validate the machine-learning model. The stopping criterion is usable to reduce overfitting of the machine-learning model, reduce computational resource consumption, and promote an ability of the machine-learning model to address previously unseen data, i.e., that is not included specifically as an example in the training data. Examples of a stopping criterion include but are not limited to a predefined number of epochs, validation loss stabilization, achievement of a performance improvement threshold, whether a threshold level of accuracy has been met, or based on performance metrics such as precision and recall. If the stopping criterion has not been met (“no” from decision block 1520), the step-by-step procedure 1500 continues training of the machine-learning model using the training data (block 1518) in this example.

If the stopping criterion is met (“yes” from decision block 1520), the trained machine-learning model is then utilized to generate an output based on subsequent data (block 1522). The trained machine-learning model, for instance, is trained to perform a task as described above and therefore once trained is configured to perform that task based on subsequent data received as an input and processed by the machine-learning model.

### Training: Diffusion Training

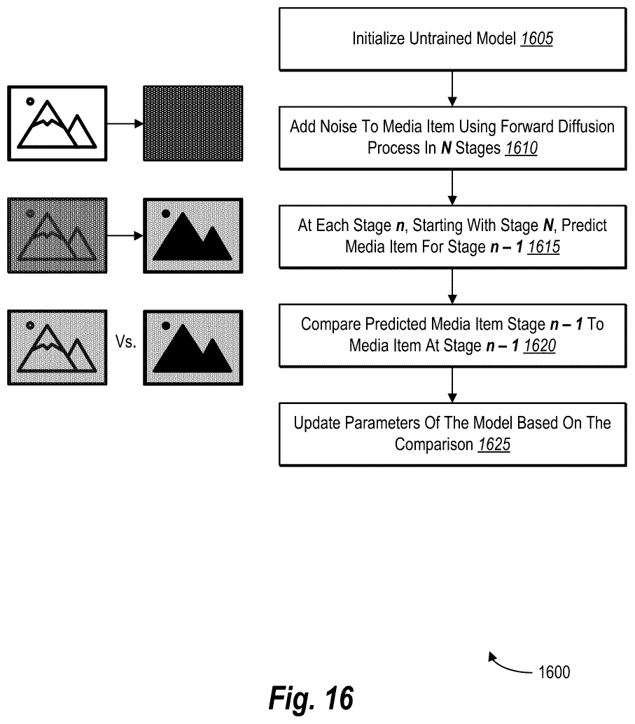

FIG. 16 shows an example of a method 1600 for training a diffusion model according to aspects of the present disclosure. In some embodiments, the method 1600 describes an operation of the training component 1825 described for configuring the diffusion neural network model 1815 as described with reference to FIG. 18. The method 1600 represents an example for training a reverse diffusion process as described above with reference to FIG. 14. In some examples, these operations are performed by a system including a processor executing a set of codes to control functional elements of an apparatus, such as the guided diffusion model described in FIG. 11.

Additionally or alternatively, certain processes of method 1600 may be performed using special-purpose hardware. Generally, these operations are performed according to the methods and processes described in accordance with aspects of the present disclosure. In some cases, the operations described herein are composed of various substeps, or are performed in conjunction with other operations.

At operation 1605, the user initializes an untrained model. Initialization can include defining the architecture of the model and establishing initial values for the model parameters. In some cases, the initialization can include defining hyper-parameters such as the number of layers, the resolution and channels of each layer blocks, the location of skip connections, and the like.

At operation 1610, the system adds noise to a media item using a forward diffusion process in N stages. In some cases, the forward diffusion process is a fixed process where Gaussian noise is successively added to media item. In latent diffusion models, the Gaussian noise may be successively added to features in a latent space.

At operation 1615, the system at each stage n, starting with stage N, a reverse diffusion process is used to predict the output or features at stage n−1. For example, the reverse diffusion process can predict the noise that was added by the forward diffusion process, and the predicted noise can be removed from the noise input to obtain the predicted output. In some cases, an original media item is predicted at each stage of the training process.

At operation 1620, the system compares predicted output (or features) at stage n−1 to an actual media item (or features), such as the output at stage n−1 or the original input. For example, given observed data x, the diffusion model may be trained to minimize the variational upper bound of the negative log-likelihood −log p_{θ}(x) of the training data.

At operation 1625, the system updates parameters of the model based on the comparison. For example, parameters of a U-Net may be updated using gradient descent. Time-dependent parameters of the Gaussian transitions can also be learned.

### System: Computing Device

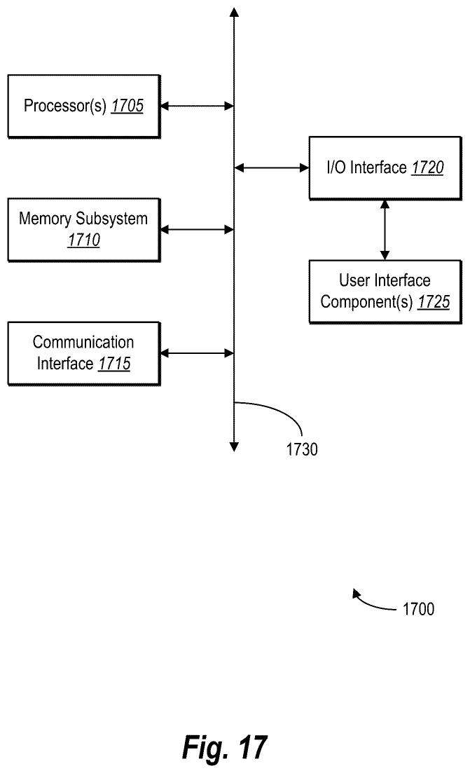

FIG. 17 shows an example of a computing device 1700 according to aspects of the present disclosure. The computing device 1700 may be an example of the synthesized image generation apparatus 1800 described with reference to FIG. 18. In one aspect, computing device 1700 includes one or more processors 1705, memory subsystem 1710, communication interface 1715, I/O interface 1720, user interface component(s) 1725, and channel 1730.

In some embodiments, computing device 1700 is an example of, or includes aspects of, the media generation model of FIG. 11. In some embodiments, computing device 1700 includes one or more processors 1705 that can execute instructions stored in memory subsystem 1710 to perform media generation.

According to some aspects, computing device 1700 includes one or more processors 1705. In some cases, a processor is an intelligent hardware device, (e.g., a general-purpose processing component, a digital signal processor (DSP), a central processing unit (CPU), a graphics processing unit (GPU), a microcontroller, an application specific integrated circuit (ASIC), a field programmable gate array (FPGA), a programmable logic device, a discrete gate or transistor logic component, a discrete hardware component, or a combination thereof. In some cases, a processor is configured to operate a memory array using a memory controller. In other cases, a memory controller is integrated into a processor. In some cases, a processor is configured to execute computer-readable instructions stored in a memory to perform various functions. In some embodiments, a processor includes special purpose components for modem processing, baseband processing, digital signal processing, or transmission processing.

According to some aspects, memory subsystem 1710 includes one or more memory devices. Examples of a memory device include random access memory (RAM), read-only memory (ROM), or a hard disk. Examples of memory devices include solid state memory and a hard disk drive. In some examples, memory is used to store computer-readable, computer-executable software including instructions that, when executed, cause a processor to perform various functions described herein. In some cases, the memory contains, among other things, a basic input/output system (BIOS) which controls basic hardware or software operation such as the interaction with peripheral components or devices. In some cases, a memory controller operates memory cells. For example, the memory controller can include a row decoder, column decoder, or both. In some cases, memory cells within a memory store information in the form of a logical state.

According to some aspects, communication interface 1715 operates at a boundary between communicating entities (such as computing device 1700, one or more user devices, a cloud, and one or more databases) and channel 1730 and can record and process communications. In some cases, communication interface 1715 is provided to enable a processing system coupled to a transceiver (e.g., a transmitter and/or a receiver). In some examples, the transceiver is configured to transmit (or send) and receive signals for a communications device via an antenna.

According to some aspects, I/O interface 1720 is controlled by an I/O controller to manage input and output signals for computing device 1700. In some cases, I/O interface 1720 manages peripherals not integrated into computing device 1700. In some cases, I/O interface 1720 represents a physical connection or port to an external peripheral. In some cases, the I/O controller uses an operating system such as iOS®, ANDROID®, MS-DOS®, MS-WINDOWS®, OS/2®, UNIX®, LINUX®, or other known operating system. In some cases, the I/O controller represents or interacts with a modem, a keyboard, a mouse, a touchscreen, or a similar device. In some cases, the I/O controller is implemented as a component of a processor. In some cases, a user interacts with a device via I/O interface 1720 or via hardware components controlled by the I/O controller.

According to some aspects, user interface component(s) 1725 enable a user to interact with computing device 1700. In some cases, user interface component(s) 1725 include an audio device, such as an external speaker system, an external display device such as a display screen, an input device (e.g., a remote-control device interfaced with a user interface directly or through the I/O controller), or a combination thereof. In some cases, user interface component(s) 1725 include a GUI.

### System: Synthesized Image Generation Apparatus

FIG. 18 shows an example of a synthesized image generation apparatus 1800 according to aspects of the present disclosure. Synthesized image generation apparatus 1800 may include an example of, or aspects of, the guided diffusion model described with reference to FIG. 11 and the U-Net described with reference to FIG. 12. In some embodiments, synthesized image generation apparatus 1800 includes processor unit 1805, memory unit 1810, diffusion neural network model 1815, I/O module 1820, and training component 1825. Training component 1825 updates parameters of the diffusion neural network model 1815 stored in memory unit 1810. In some examples, the training component 1825 is located outside the synthesized image generation apparatus 1800.

Processor unit 1805 includes one or more processors. A processor is an intelligent hardware device, such as a general-purpose processing component, a digital signal processor (DSP), a central processing unit (CPU), a graphics processing unit (GPU), a microcontroller, an application specific integrated circuit (ASIC), a field programmable gate array (FPGA), a programmable logic device, a discrete gate or transistor logic component, a discrete hardware component, or any combination thereof.

In some cases, processor unit 1805 is configured to operate a memory array using a memory controller. In other cases, a memory controller is integrated into processor unit 1805. In some cases, processor unit 1805 is configured to execute computer-readable instructions stored in memory unit 1810 to perform various functions. In some aspects, processor unit 1805 includes special purpose components for modem processing, baseband processing, digital signal processing, or transmission processing. According to some aspects, processor unit 1805 comprises one or more processors described with reference to FIG. 17.

Memory unit 1810 includes one or more memory devices. Examples of a memory device include random access memory (RAM), read-only memory (ROM), or a hard disk. Examples of memory devices include solid state memory and a hard disk drive. In some examples, memory is used to store computer-readable, computer-executable software including instructions that, when executed, cause at least one processor of processor unit 1805 to perform various functions described herein.

In some cases, memory unit 1810 includes a basic input/output system (BIOS) that controls basic hardware or software operations, such as an interaction with peripheral components or devices. In some cases, memory unit 1810 includes a memory controller that operates memory cells of memory unit 1810. For example, the memory controller may include a row decoder, column decoder, or both. In some cases, memory cells within memory unit 1810 store information in the form of a logical state. According to some aspects, memory unit 1810 is an example of the memory subsystem 1710 described with reference to FIG. 17.

According to some aspects, synthesized image generation apparatus 1800 uses one or more processors of processor unit 1805 to execute instructions stored in memory unit 1810 to perform functions described herein. For example, the synthesized image generation apparatus 1800 may generate synthesized digital images based on one or more reference digital images and a text prompt.

The memory unit 1810 may include a diffusion neural network model 1815 trained to generate synthesized digital images based on a composite embedding. For example, after training, the diffusion neural network model 1815 may perform inferencing operations as described with reference to FIGS. 13 and 14 to generate synthesized digital images based on a composite embedding.

In some embodiments, the diffusion neural network model 1815 is an Artificial neural network (ANN) such as the guided diffusion model described with reference to FIG. 11 and the U-Net described with reference to FIG. 12. An ANN can be a hardware component or a software component that includes connected nodes (i.e., artificial neurons) that loosely correspond to the neurons in a human brain. Each connection, or edge, transmits a signal from one node to another (like the physical synapses in a brain). When a node receives a signal, it processes the signal and then transmits the processed signal to other connected nodes.

ANNs have numerous parameters, including weights and biases associated with each neuron in the network, which control the degree of connection between neurons and influence the neural network's ability to capture complex patterns in data. These parameters, also known as model parameters or model weights, are variables that determine the behavior and characteristics of a machine learning model.

In some cases, the signals between nodes comprise real numbers, and the output of each node is computed by a function of its inputs. For example, nodes may determine their output using other mathematical algorithms, such as selecting the max from the inputs as the output, or any other suitable algorithm for activating the node. Each node and edge are associated with one or more node weights that determine how the signal is processed and transmitted. In some cases, nodes have a threshold below which a signal is not transmitted at all. In some examples, the nodes are aggregated into layers.

The parameters of diffusion neural network model 1815 can be organized into layers. Different layers perform different transformations on their inputs. The initial layer is known as the input layer and the last layer is known as the output layer. In some cases, signals traverse certain layers multiple times. A hidden (or intermediate) layer includes hidden nodes and is located between an input layer and an output layer. Hidden layers perform nonlinear transformations of inputs entered into the network. Each hidden layer is trained to produce a defined output that contributes to a joint output of the output layer of the ANN. Hidden representations are machine-readable data representations of an input that are learned from hidden layers of the ANN and are produced by the output layer. As the understanding of the ANN of the input improves as the ANN is trained, the hidden representation is progressively differentiated from earlier iterations.

Training component 1825 may train the diffusion neural network model 1815. For example, parameters of the diffusion neural network model 1815 can be learned or estimated from training data and then used to make predictions or perform tasks based on learned patterns and relationships in the data. In some examples, the parameters are adjusted during the training process to minimize a loss function or maximize a performance metric (e.g., as described with reference to FIGS. 15 and 16). The goal of the training process may be to find optimal values for the parameters that allow the machine learning model to make accurate predictions or perform well on the given task.

Accordingly, the node weights can be adjusted to improve the accuracy of the output (i.e., by minimizing a loss which corresponds in some way to the difference between the current result and the target result). The weight of an edge increases or decreases the strength of the signal transmitted between nodes. For example, during the training process, an algorithm adjusts machine learning parameters to minimize an error or loss between predicted outputs and actual targets according to optimization techniques like gradient descent, stochastic gradient descent, or other optimization algorithms. Once the machine learning parameters are learned from the training data, the diffusion neural network model 1815 can be used to make predictions on new, unseen data (i.e., during inference).

I/O module 1820 receives inputs from and transmits outputs of the synthesized image generation apparatus 1800 to other devices or users. For example, I/O module 1820 receives inputs for the diffusion neural network model 1815 and transmits outputs of the diffusion neural network model 1815. According to some aspects, I/O module 1820 is an example of the I/O interface 1720 described with reference to FIG. 17.

Embodiments of the present disclosure may comprise or utilize a special purpose or general-purpose computer including computer hardware, such as, for example, one or more processors and system memory, as discussed in greater detail below. Embodiments within the scope of the present disclosure also include physical and other computer-readable media for carrying or storing computer-executable instructions and/or data structures. In particular, one or more of the processes described herein may be implemented at least in part as instructions embodied in a non-transitory computer-readable medium and executable by one or more computing devices (e.g., any of the media content access devices described herein). In general, a processor (e.g., a microprocessor) receives instructions, from a non-transitory computer-readable medium, (e.g., a memory, etc.), and executes those instructions, thereby performing one or more processes, including one or more of the processes described herein.

Computer-readable media can be any available media that can be accessed by a general purpose or special purpose computer system. Computer-readable media that store computer-executable instructions are non-transitory computer-readable storage media (devices). Computer-readable media that carry computer-executable instructions are transmission media. Thus, by way of example, and not limitation, embodiments of the disclosure can comprise at least two distinctly different kinds of computer-readable media: non-transitory computer-readable storage media (devices) and transmission media. Non-transitory computer-readable storage media (devices) includes optical and/or non-optical memory, disks, or caches that store computer data interpretable by one or more processors to execute particular functions as described herein. A “network” is defined as one or more data links that enable the transport of electronic data between computer systems and/or modules and/or other electronic devices. Information is transferred or provided over a network (either hardwired, wireless, or a combination of hardwired or wireless) to a computer to carry program code in the form of computer-executable instructions or data structures and which can be accessed by a general purpose or special purpose computer.

Computer-executable instructions comprise, for example, instructions and data which, when executed at a processor, cause a general-purpose computer, special purpose computer, or special purpose processing device to perform a certain function or group of functions. In some embodiments, computer-executable instructions are executed on a general-purpose computer to turn the general-purpose computer into a special purpose computer implementing elements of the disclosure. The computer executable instructions may be, for example, binaries, intermediate format instructions such as assembly language, or even source code.

Embodiments of the present disclosure can also be implemented in cloud computing environments. In this description, “cloud computing” is defined as a model for enabling on-demand network access to a shared pool of configurable computing resources. A cloud-computing model can also expose various service models, such as, for example, Software as a Service (“SaaS”), Platform as a Service (“PaaS”), and Infrastructure as a Service (“IaaS”). A cloud-computing model can also be deployed using different deployment models such as private cloud, community cloud, public cloud, hybrid cloud, and so forth.

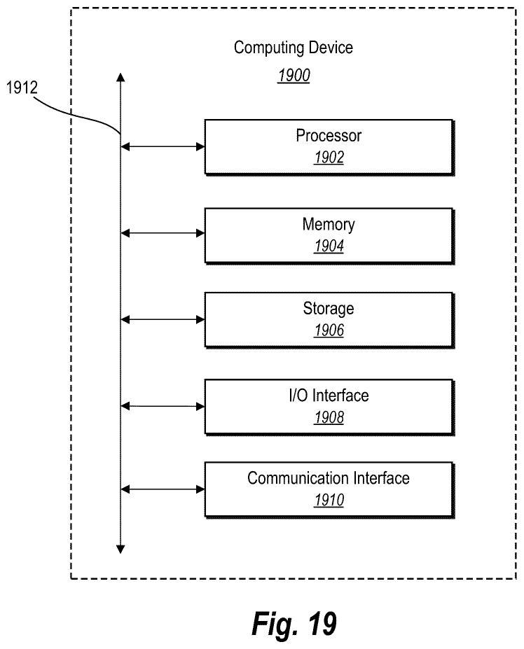

FIG. 19 illustrates, in block diagram form, an example computing device 1900 (e.g., the computing device(s) 900, the client device 116, and/or the server device(s) 102) that may be configured to perform one or more of the processes described above. As shown by FIG. 19, the computing device can comprise a processor(s) 1902, memory 1904, a storage device 1906, an I/O interface 1908, and a communication interface 1910.

In particular embodiments, processor(s) 1902 includes hardware for executing instructions, such as those making up a computer program. As an example, and not by way of limitation, to execute instructions, processor(s) 1902 may retrieve (or fetch) the instructions from an internal register, an internal cache, memory 1904, or a storage device 1906 and decode and execute them. The computing device 1900 includes memory 1904, which is coupled to the processor(s) 1902. The memory 1904 may be used for storing data, metadata, and programs for execution by the processor(s). The memory 1904 may include one or more of volatile and non-volatile memories. The memory 1904 may be internal or distributed memory. The computing device 1900 includes a storage device 1906 includes storage for storing data or instructions. As an example, and not by way of limitation, storage device 1906 can comprise a non-transitory storage medium described above. The computing device 1900 also includes one or more input or output (“I/O”) devices/interfaces 1908, which are provided to allow a user to provide input to (such as user strokes), receive output from, and otherwise transfer data to and from the computing device 1900. These I/O devices/interfaces 1908 may include a mouse, keypad or a keyboard, a touch screen, camera, optical scanner, network interface, modem, other known I/O devices or a combination of such I/O devices/interfaces 1908.

The computing device 1900 can further include a communication interface 1910. The communication interface 1910 can include hardware, software, or both. The communication interface 1910 can provide one or more interfaces for communication (such as, for example, packet-based communication) between the computing device and one or more other computing devices (e.g., computing device 1900) or one or more networks. The computing device 1900 can further include a bus 1912. The bus 1912 can comprise hardware, software, or both that couples components of computing device 1900 to each other.

What is claimed is:

1. A computer-implemented method comprising:
generating, utilizing one or more encoder neural networks, a set of input tokens from a prompt comprising a description of a target digital design and one or more categorical parameters for the target digital design;
generating, utilizing a diffusion neural network and based on the set of input tokens, a plurality of design layers including digital design elements according to the description of the target digital design; and
providing, for display within a digital design application of a client device, the target digital design having document attributes corresponding to the one or more categorical parameters and comprising the digital design elements of the plurality of design layers as separately interactive elements.

2. The computer-implemented method of claim 1, wherein generating the set of input tokens further comprises generating an expanded description by prompting a large language model to generate additional details related to the description of the target digital design.

3. The computer-implemented method of claim 1, wherein generating the set of input tokens comprises:
providing, to the client device, a set of selectable categorical parameters; and
determining the one or more categorical parameters for the target digital design in response to one or more selections from the set of selectable categorical parameters via the client device.

4. The computer-implemented method of claim 1, wherein generating the set of input tokens further comprises determining the one or more categorical parameters by generating a prompt to cause a large language model to extract the one or more categorical parameters from the description of the target digital design.

5. The computer-implemented method of claim 1, wherein generating the set of input tokens further comprises:
generating, utilizing an encoder neural network, an image embedding from a reference digital design;
generating, based on a client device interaction, a layer number embedding representing a target number of design layers for the target digital design; and
combining the image embedding with a prompt embedding representing the prompt and a layer number embedding in the set of input tokens.

6. The computer-implemented method of claim 1, wherein generating the plurality of design layers comprises generating a design layer of the plurality of design layers comprising:
a background design layer including a background digital design element;
a shape design layer including a vectorial digital design element;
a text design layer including a text digital design element; or
an image design layer including an image digital design element.

7. The computer-implemented method of claim 6, wherein generating the design layer comprises:
determining digital design element types for a plurality of digital design elements generated utilizing the diffusion neural network;
identifying one or more non-overlapping digital design elements sharing a digital design element type; and
generating the design layer according to the digital design element type of the one or more non-overlapping digital design elements.

8. The computer-implemented method of claim 7, further comprising:
identifying the design layer within the plurality of design layers as a text design layer; and
transforming the one or more non-overlapping digital design elements within the text design layer into editable text digital design elements.

9. The computer-implemented method of claim 1, wherein providing the target digital design further comprises:
generating a modified target digital design in response to one or more client device interactions with an interactive element of the separately interactive elements of the target digital design; and
providing the modified target digital design for display within the digital design application of the client device.

10. The computer-implemented method of claim 1, wherein providing the target digital design further comprises:
generating, utilizing the diffusion neural network, an initial digital design comprising the plurality of design layers at a first resolution; and
generating, by upsampling the initial digital design, the target digital design at a second resolution higher than the first resolution.

11. A system comprising:
one or more memory devices; and
one or more processors coupled to the one or more memory devices that cause the system to perform operations comprising:
determining, in response to a text input via a client device, a text prompt comprising a natural language description of a target digital design;
determining, in response to one or more parameter selections via the client device, a condition prompt comprising one or more categorical parameters for the target digital design;
generating, utilizing one or more encoder neural networks, a set of input tokens from the text prompt and the condition prompt;
generating, utilizing a diffusion neural network and based on the set of input tokens, a plurality of design layers including digital design elements of different element types according to the natural language description of the target digital design;
providing, for display within a digital design application of a client device, the target digital design having document attributes corresponding to the one or more categorical parameters and comprising the digital design elements of the plurality of design layers as separately interactive elements.

12. The system of claim 11, wherein generating the set of input tokens further comprises:
generating, utilizing a large language model in response to determining the text prompt from the text input via the client device, an expanded description comprising additional details related to the natural language description of the target digital design;
determining a reference digital design comprising a style for conditioning the diffusion neural network; and
combining embeddings representing the expanded description, the condition prompt, the reference digital design, and a plurality of noisy tokens in the set of input tokens.

13. The system of claim 11, wherein generating the set of input tokens further comprises:
determining a target number of design layers for the target digital design;
generating, utilizing the one or more encoder neural networks, a layer number embedding representing the target number of design layers; and
including the layer number embedding in the set of input tokens.

14. The system of claim 11, wherein providing the target digital design further comprises:
determining digital design element types for the digital design elements of the plurality of design layers;
determining design layer types for the plurality of design layers based on the digital design element types; and
arranging the design layers within the plurality of design layers according to the design layer types.

15. The system of claim 11, wherein determining the condition prompt comprises:
providing one or more selectable categorical parameters to the client device including a document parameter, an aspect ratio parameter, a style parameter, and a mood parameter; and
determining the condition prompt based on a client device selection of the one or more selectable categorical parameters.

16. A non-transitory computer-readable medium storing instructions thereon that, when executed by at least one processor, cause the at least one processor to perform operations comprising:
generating, utilizing one or more encoder neural networks, a set of input tokens from a prompt comprising a description of a target digital design and one or more categorical parameters for the target digital design;
generating, utilizing a diffusion neural network and based on the set of input tokens, a plurality of design layers including digital design elements according to the description of the target digital design; and
providing, for display within a digital design application of a client device, the target digital design having document attributes corresponding to the one or more categorical parameters and comprising the digital design elements of the plurality of design layers as separately interactive elements.

17. The non-transitory computer-readable medium of claim 16, wherein generating the set of input tokens further comprises:
generating, utilizing a large language model, an expanded description of the target digital design from the description of the target digital design
generating the one or more categorical parameters for the target digital design by inferring the one or more categorical parameters from the description of the target digital design;
determining a reference digital design including a target style for the target digital design;
determining a target number of design layers for the target digital design; and
generating the set of input tokens by combining embeddings representing the expanded description, the one or more categorical parameters, the reference digital design, and the target number of design layers with a plurality of noisy tokens.

18. The non-transitory computer-readable medium of claim 16, wherein generating the plurality of design layers includes:
determining design layer types of the plurality of design layers based on digital design element types of the digital design elements of the plurality of design layers; and
arranging the plurality of design layers according to design layer types of the plurality of design layers.

19. The non-transitory computer-readable medium of claim 16, further comprising:
generating a layered training set by labeling one or more design layers within a set of sample layered digital designs;
generating an unlayered training set from a set of sample unlayered digital designs; and
adjusting parameters of the diffusion neural network to generate target digital designs including layered data in a hybrid training process utilizing the layered training set and the unlayered training set.

20. The non-transitory computer-readable medium of claim 19, wherein generating the layered training set comprises:
determining a target number of design layers for the set of sample layered digital designs;
identifying one or more sample layered digital designs with a number of design layers less than the target number of design layers; and
padding the one or more sample layered digital designs with one or more zero-frame layers until reaching the target number of design layers.
